(19) United States
(12) Patent Application Publication
(10) Pub. No.: US 2022/0209898 A1
(43) Pub. Date: Jun. 30, 2022

(54) CODE BLOCK GROUP (CBG) LEVEL RETRANSMISSION ON CONFIGURED GRANT RESOURCES

(71) Applicant: TELEFONAKTIEBOLAGET LM ERICSSON (PUBL), Stockholn (SE)

(72) Inventors: Reem Karaki, AACHEN (DE); Jung-Fu Cheng, FREMONT, CA (US)

(21) Appl. No.: 17/609,894

(22) PCT Filed: May 11, 2020
(86) PCT No.: PCT/IB2020/054444

§ 371 Date: Nov. 9, 2021

Related U.S. Application Data
(60) Provisional application No. 62/847,871, filed on May 14, 2019.

(51) Int. Cl. H04L 1/08; H04L 5/00; H04W 72/14

(52) U.S. Cl. CPC H04L 1/08; H04W 72/14; H04L 5/0055

(57) ABSTRACT

Methods and apparatus are provided to support CBG-based retransmission on configured UL resources. The base station provides downlink feedback information (DPI) to the UE for one or more HARQ processes. The DPI comprises TB-level feedback, retransmission control information, and CBG-level feedback. The TB-level feedback indicates, for each HARQ process, ACK/NACK of a transport block associated with the HARQ process. The retransmission control information indicates, for each NACK'ed TB, whether the base station expects retransmission at the TB level or a CBG level. The CBG-level feedback indicates, for each NACK'ed TB where the CBG-indicator bitmap indicates code block group level retransmission, ACK/NACK for one or more CBGs in the NACK'ed transport block.

### RELATED APPLICATIONS

This application claims priority to U.S. Application No. 62/847,871, filed 14 May 2019, the disclosure of which is incorporated in its entirety by reference herein.

### TECHNICAL FIELD

The present disclosure relates generally to retransmission protocols for wireless communication network and, more particularly, to code block group (CBG) based retransmission on configured grant resources.

### BACKGROUND

The Third Generation Partnership Project (3GPP) is defining technical specifications for New Radio (NR), which is being designed to provide service for multiple use cases such as Enhanced Mobile Broadband (eMBB), Ultra-Reliable and Low Latency Communication (URLLC), and Machine Type Communication (MTC). Each of these services has different technical requirements. For example, the general requirement for eMBB is high data rate with moderate latency and moderate coverage, while URLLC service requires a low latency and high reliability transmission but perhaps for moderate data rates.

One of the solutions for low latency data transmission is shorter transmission time intervals. In NR in addition to transmission in a slot, a mini-slot transmission is also allowed to reduce latency. A mini-slot may consist of any number of 1 to 14 OFDM symbols. It should be noted that the concepts of slot and mini-slot are not specific to a specific service meaning that a mini-slot may be used for either eMBB, URLLC, or other services.

Like Long Term Evolution (LTE) systems, NR systems allow a transport block (TB) to be divided into multiple code blocks (CB). Each CB comprises a segment of the TB along with a separate cyclic redundancy check (CRC) appended to the TB segment. CBs can be grouped into CB groups (CBGs).

### SUMMARY

The present disclosure relates to code block group (CBG)-based retransmission on configured grant resources. The base station provides downlink feedback information (DFI) to the UE for one or more acknowledgement processes. The DFI comprises TB-level feedback, retransmission control information, and CBG-level feedback. The TB-level feedback indicates, for each acknowledgement process, an acknowledgement (ACK) or negative acknowledgement (NACK) of a transport block associated with the acknowledgement process. The retransmission control information indicates, for each NACK'ed TB, whether the base station expects TB-based retransmission or CBG-based retransmission. The CBG-level feedback indicates, for each NACK'ed TB where the CBG-indicator bitmap indicates CBG-based retransmission, an acknowledgement (ACK) or negative acknowledgement (NACK) for one or more CBGs in the NACK'ed transport block.

A first aspect of the disclosure comprises methods of retransmission implemented by a user equipment. The method comprises receiving, for each of one or more acknowledgement processes, transport block level feedback indicating an acknowledgement (ACK) or negative acknowledgement (NACK) for a transport block associated with the acknowledgement process. The method further comprises receiving, for each of one or more negatively acknowledged transport blocks, retransmission control information indicating whether the base station expects retransmission at the transport block level or code block group level. The method further comprises, for one or more negatively acknowledged transport blocks where code block group level retransmission is indicated by the retransmission control information, receiving code block group level feedback indicating an acknowledgement (ACK) or negative acknowledgement (NACK) for each of one or more code block groups in the transport block. The method further comprises retransmitting one or more of the negatively acknowledged code block groups in the negatively acknowledged transport blocks for which code block group level retransmission is indicated.

A second aspect of the disclosure comprises method implemented by a base station. The method comprises transmitting, for each of one or more acknowledgement processes, transport block level feedback indicating an acknowledgement (ACK) or negative acknowledgement (NACK) of a transport block associated with the acknowledgement process. The method further comprises transmitting, for one or more negatively acknowledged transport blocks, retransmission control information indicating whether the base station expects retransmission at a transport block level or a code block group level. The method further comprises, for one or more negatively acknowledged transport blocks where code block group level retransmission is indicated by the retransmission control information, transmitting code block group level feedback indicating an acknowledgement (ACK) or negative acknowledgement (NACK) for one or more code block groups in the transport block.

A third aspect of the disclosure comprises a user equipment configured for retransmitting data. The user equipment is configured to receive, for each of one or more acknowledgement processes, transport block level feedback indicating an acknowledgement (ACK) or negative acknowledgement (NACK) for a transport block associated with the acknowledgement process. The user equipment is configured to receive, for each of one or more negatively acknowledged transport blocks, retransmission control information indicating whether the base station expects retransmission at the transport block level or code block group level. The user equipment is configured to receive, for one or more negatively acknowledged transport blocks where code block group level retransmission is indicated by the retransmission control information, code block group level feedback indicating an acknowledgement (ACK) or negative acknowledgement (NACK) for each of one or more code block groups in the transport block. The user equipment is configured to retransmit one or more of the negatively acknowledged code block groups in the negatively acknowledged transport blocks for which code block group level retransmission is indicated.

A fourth aspect of the disclosure comprises a base station configured to provide feedback for uplink transmissions. The base station is configured to transmit, for each of one or more acknowledgement processes, transport block level feedback indicating an acknowledgement (ACK) or negative acknowledgement (NACK) of a transport block associated with the acknowledgement process. The base station is further configured to transmit, for one or more negatively acknowledged transport blocks, retransmission control information indicating whether the base station expects retransmission at a transport block level or a code block group level. The base station is further configured to, for one or more negatively acknowledged transport blocks where code block group level retransmission is indicated by the retransmission control information, transmitting code block group level feedback indicating an acknowledgement (ACK) or negative acknowledgement (NACK) for one or more code block groups in the transport block.

A fifth aspect of the disclosure comprises a user equipment having communication circuitry for communicating with a base station and processing circuitry. The processing circuitry is configured to receive, for each of one or more acknowledgement processes, transport block level feedback indicating an acknowledgement (ACK) or negative acknowledgement (NACK) for a transport block associated with the acknowledgement process. The processing circuitry is configured to receive, for each of one or more negatively acknowledged transport blocks, retransmission control information indicating whether the base station expects retransmission at the transport block level or code block group level. The processing circuitry is further configured to receive, for one or more negatively acknowledged transport blocks where code block group level retransmission is indicated by the retransmission control information, code block group level feedback indicating an acknowledgement (ACK) or negative acknowledgement (NACK) for each of one or more code block groups in the transport block. The processing circuitry is configured to retransmit one or more of the negatively acknowledged code block groups in the negatively acknowledged transport blocks for which code block group level retransmission is indicated.

A sixth aspect of the disclosure comprises a base station having communication circuitry for communicating with a UE and processing circuitry. The processing circuitry is configured to transmit, for each of one or more acknowledgement processes, transport block level feedback indicating an acknowledgement (ACK) or negative acknowledgement (NACK) of a transport block associated with the acknowledgement process. The processing circuitry is further configured to transmit, for one or more negatively acknowledged transport blocks, retransmission control information indicating whether the base station expects retransmission at a transport block level or a code block group level. The processing circuitry is further configured to, for one or more negatively acknowledged transport blocks where code block group level retransmission is indicated by the retransmission control information, transmitting code block group level feedback indicating an acknowledgement (ACK) or negative acknowledgement (NACK) for one or more code block groups in the transport block.

A seventh aspect of the disclosure comprises a computer program for a UE in a communication network. The computer program comprises executable instructions that, when executed by processing circuitry in the UE, causes the UE to receive, for each of one or more acknowledgement processes, transport block level feedback indicating an acknowledgement (ACK) or negative acknowledgement (NACK) for a transport block associated with the acknowledgement process. The executable instructions further cause the UE to receive, for each of one or more negatively acknowledged transport blocks, retransmission control information indicating whether the base station expects retransmission at the transport block level or code block group level. The executable instructions further cause the UE to receive, for one or more negatively acknowledged transport blocks where code block group level retransmission is indicated by the retransmission control information, code block group level feedback indicating an acknowledgement (ACK) or negative acknowledgement (NACK) for each of one or more code block groups in the transport block. The executable instructions further cause the UE to retransmit one or more of the negatively acknowledged code block groups in the negatively acknowledged transport blocks for which code block group level retransmission is indicated.

An eighth aspect of the disclosure comprises a carrier containing a computer program according to the seventh aspect. The carrier is one of an electronic signal, optical signal, radio signal, or a non-transitory computer readable storage medium.

A ninth aspect of the disclosure comprises a computer program for a base station in a communication network. The computer program comprises executable instructions that, when executed by processing circuitry in the base station, causes the base station to transmit, for each of one or more acknowledgement processes, transport block level feedback indicating an acknowledgement (ACK) or negative acknowledgement (NACK) of a transport block associated with the acknowledgement process. The executable instructions further cause the base station to transmit, for one or more negatively acknowledged transport blocks, retransmission control information indicating whether the base station expects retransmission at a transport block level or a code block group level. The executable instructions further cause the base station to, for one or more negatively acknowledged transport blocks where code block group level retransmission is indicated by the retransmission control information, transmitting code block group level feedback indicating an acknowledgement (ACK) or negative acknowledgement (NACK) for one or more code block groups in the transport block.

A tenth aspect of the disclosure comprises a carrier containing a computer program according to the ninth aspect. The carrier is one of an electronic signal, optical signal, radio signal, or a non-transitory computer readable storage medium.

### BRIEF DESCRIPTION OF THE DRAWINGS

FIG. 1 illustrates an exemplary communication network according to an embodiment.

FIG. 2 illustrates time-frequency resources in an NR network.

FIG. 3 illustrates the slot structure used in NR networks.

FIGS. 4A-4B illustrates different resource allocation for a slot with 14 symbols.

FIG. 5 illustrates a mini-slot.

FIG. 6 illustrates a transport block with multiple CBGs used for uplink transmission.

FIG. 7 illustrates a method implemented by a base station configured to support CBG-based retransmission.

FIG. 8 illustrates a method implemented by a UE configured to implement CBG-based retransmission.

FIG. 9 is a functional block diagram of an exemplary base station configured to support CBG-based retransmission.

FIG. 10 is a functional block diagram of an exemplary UE configured to implement CBG-based retransmission.

FIG. 11 illustrates the main components of an exemplary base station configured to support CBG-based retransmission.

FIG. 12 illustrates the main components of an exemplary UE configured to implement CBG-based retransmission.

FIG. 13 illustrates an exemplary wireless network according to an embodiment.

FIG. 14 illustrates an exemplary UE according to an embodiment.

FIG. 15 illustrates an exemplary virtualization environment according to an embodiment.

FIG. 16 illustrates an exemplary telecommunication network connected via an intermediate network to a host computer according to an embodiment.

FIG. 17 illustrates an exemplary host computer communicating via a base station with a user equipment over a partially wireless connection according to an embodiment.

FIGS. 18-21 illustrate an exemplary method implemented in a communication system, according to an embodiment.

### DETAILED DESCRIPTION

Referring now to the drawings, an exemplary embodiment of the disclosure will be described in the context of a 5G or NR wireless communication network. Those skilled in the art will appreciate that the methods and apparatus herein described are not limited to use in 5G or NR networks, but may also be used in wireless communication networks 10 where multiple beams within a single cell are used for communication with wireless devices in the cell.

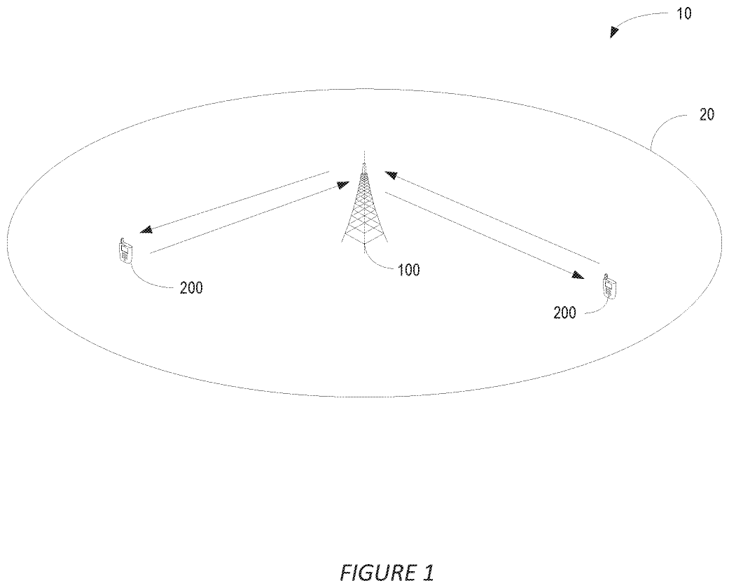

FIG. 1 illustrates a wireless communication network 10 according to the NR standard currently being developed by Third Generation Partnership Project (3GPP). The wireless communication network 10 comprises one or more base stations 100 providing service to user equipment (UEs) 200 in respective cells 20 of the wireless communication network 10. The base stations 100 are also referred to as Evolved NodesBs (eNBs) and Fifth Generation (5G) NodeBs (gNBs) in 3GPP standards. Although only one cell 20 and one base station 100 are shown in FIG. 1, those skilled in the art will appreciate that a typical wireless communication network 10 comprises many cells 20 served by many base stations 100.

The UEs 200 may comprise any type of equipment capable of communicating with the base station 100 over a wireless communication channel. For example, the UEs 200 may comprise cellular telephones, smart phones, laptop computers, notebook computers, tablets, machine-to-machine (M2M) devices (also known as machine type communication (MTC) devices), embedded devices, wireless sensors, or other types of wireless end user devices capable of communicating over wireless communication networks 10.

Radio Resources

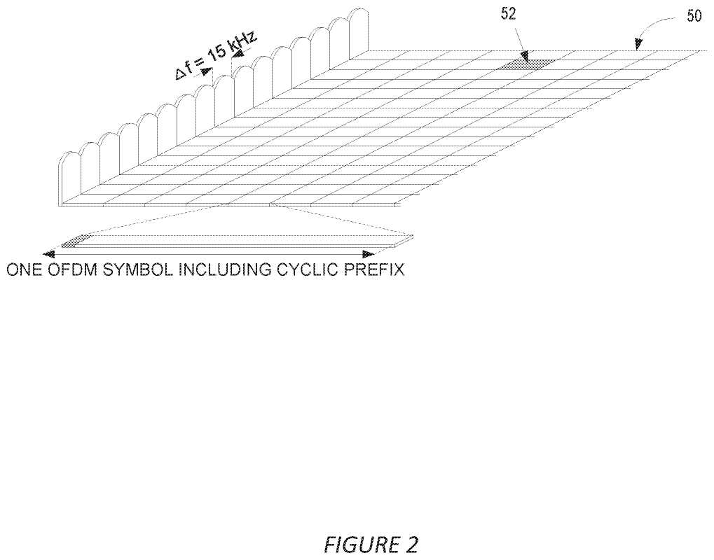

The radio resources in NR can be viewed as a time-frequency grid 50 as shown in FIG. 2. In the time domain, the physical resources are divided into slots. Each slots includes a number of symbols. In one embodiment, a slot comprises 7 or 14 orthogonal frequency division multiplexing (OFDM) symbols for subcarrier spacing (SCS) less than or equal to 60 Hz, and 14 OFDM symbols for SCS greater than 60 Hz. In the frequency domain, the physical resources are divided into subcarriers. The number of subcarriers varies according to the allocated system bandwidth. In NR, a slot can be subdivided into mini-slots. A mini-slot comprises one or more symbol periods in a time slot. The smallest element of the time-frequency grid 50 is a resource element (RE) 52, which comprises the intersection of one subcarrier and one symbol.

In release 15 (Rel-15) of the NR standard, a UE 200 can be configured with up to four carrier bandwidth parts (BWPs) in the downlink (DL) with a single DL carrier BWP being active at a given time. A UE 200 can be configured with up to four carrier BWPs in the uplink (UL) with a single UL carrier BWP being active at a given time. If a UE 200 is configured with a supplementary UL, the UE 200 can additionally be configured with up to four carrier BWPs in the supplementary UL with a single supplementary UL carrier BWP being active at a given time.

For a carrier BWP with a given numerology μᵢ, a contiguous set of physical resource blocks (PRBs) are defined and numbered from 0 to N_{BWP,i}^{size}−1, where i is the index of the carrier BWP. A resource block (RB) is defined as 12 consecutive subcarriers in the frequency domain.

Numerologies

Multiple Orthogonal Frequency-Division Multiplexing (OFDM) numerologies, μᵢ, are supported in NR as given by Table 1 below, where the subcarrier spacing, Δf, and the cyclic prefix (CP) for a carrier bandwidth part are configured by different higher layer parameters for DL and UL, respectively.

TABLE 1
Supported transmission numerologies.

| μ | Δf = 2^{μ} · 15 | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Physical Channels

The base station 100 transmits information to the UE 200 on physical DL channels. A physical DL channel corresponds to a set of REs carrying information originating from higher layers. The physical DL channels currently defined include the Physical Downlink Shared Channel (PDSCH), the Physical Downlink Control Channel (PDCCH) and the Physical Downlink Broadcast Channel (PBCH). The PDSCH is the main physical channel used for unicast DL data transmission, but also for transmission of random access responses (RARs), certain system information blocks (SIBs), and paging information. The PDCCH is used for transmitting DL control information (DCI), mainly scheduling decisions, required for reception of the PDSCH, and for UL scheduling grants (SGs) enabling transmission on Physical Uplink Shared Channel (PUSCH). The PBCH carries the basic system information (SI) required by the UE 200 to access the network 10.

The base station 100 is responsible for scheduling DL transmissions to the UE 200 on the PDSCH and for allocating resources for the DL transmissions. The base station 100 sends downlink control information (DCI) to the UE 200 on the PDCCH to schedule a DL transmission UE 200. The DCI includes scheduling information such as the allocated resources for the DL transmission and the modulation and coding scheme (MCS).

The UE 200 transmits information to the base station 100 on physical UL channels. A physical UL channel corresponds to a set of REs carrying information originating from higher layers. The physical UL channels currently defined include the Physical Uplink Shared Channel (PUSCH), the Physical Uplink Control Channel (PUCCH) and the Physical Random Access Channel (PRACH). The PUSCH is the UL counterpart to the PDSCH. The PUCCH is used by UEs 200 to transmit UL control information (UCI), including Hybrid Automatic Repeat Request (HARQ) acknowledgements, channel state information (CSI) reports, etc. The PRACH is used for random access preamble transmission.

The base station 100 is responsible for scheduling UL transmissions from the UE 200 and for allocating resources for the UL transmissions. After scheduling an UL transmission and allocating resources, the base station 100 sends a scheduling grant (SG) to the UE 200 indicating the resources on which the UE 200 has been scheduled and the transmission format for the scheduled transmission. The UL grant is sent to the UE 200 on the PDCCH. After receiving the UL grant, the UE 200 determines the UL transmit power for the transmission and transmits data to the base station 100 on the PUSCH resources indicated in the SG.

Frequency Resource Allocation for PUSCH and PDSCH

In general, a UE 200 shall determine the RB assignment in frequency domain for PUSCH or PDSCH using the resource allocation field in the detected DCI carried in PDCCH. For PUSCH carrying Message3 (MSG3) in a random-access procedure, the frequency domain resource assignment is signaled by using the UL grant contained in random access response (RAR).

In NR, two frequency resource allocation schemes, type 0 and type 1, are supported for PUSCH and PDSCH. Which type to use for a PUSCH/PDSCH transmission is either defined by a radio resource control (RRC) configured parameter or indicated directly in the corresponding downlink control information (DCI) or by an UL grant in RAR (for which type 1 is used).

The RB indexing for uplink/downlink type 0 and type 1 resource allocation is determined within the UE's active carrier bandwidth part, and the UE 200 shall upon detection of PDCCH intended for the UE 200 determine first the uplink/downlink carrier bandwidth part and then the resource allocation within the carrier bandwidth part. The UL BWP for PUSCH carrying MSG3 is configured by higher layer parameters.

Cell Search and Initial Access Related Channels and Signal

For cell search and initial access, these channels are included: the synchronization signal (SS) and PBCH block (SS/PBCH block), PDSCH carrying Remaining Minimum System Information (RMSI), RAR, and Message 4 (MSG4) scheduled by PDCCH channels carrying DCI, Physical Random Access Channels (PRACHs) and PUSCH channel carrying MSG3.

The SS/PBCH block, or synchronization signaling block (SSB) in shorter format, comprises the primary synchronization signal (PSS), secondary synchronization signal (SSS), PBCH demodulation reference signals (DMRS), and PBCH. The SSB may have SCS of 15 kHz, 30 kHz, 120 kHz or 240 kHz depending on the frequency range.

PDCCH Monitoring

In the NR standard, DCI is received over the PDCCH. The PDCCH may carry DCI in messages with different formats. DCI format 0_0 and 0_1 are DCI messages used to convey uplink grants to the UE 200 for transmission of the physical layer data channel in the uplink (PUSCH) and DCI format 1_0 and 1_1 are used to convey downlink grants for transmission of the physical layer data channel on the downlink (PDSCH). Other DCI formats (2_0, 2_1, 2_2 and 2_3) are used for other purposes such as transmission of slot format information, reserved resource, transmit power control information etc.

A PDCCH candidate is searched within a common or UE-specific search space which is mapped to a set of time and frequency resources referred to as a control resource set (CORESET). The search spaces within which PDCCH candidates must be monitored are configured to the UE 200 via RRC signaling. A monitoring periodicity is also configured for different PDCCH candidates. In any particular slot the UE 200 may be configured to monitor multiple PDCCH candidates in multiple search spaces which may be mapped to one or more CORESETs. PDCCH candidates may need to be monitored multiple times in a slot, once every slot or once in multiple of slots.

The smallest unit used for defining CORESETs is a Resource Element Group (REG) which is defined as spanning 1 PRB×1 OFDM symbol in frequency and time. Each REG contains demodulation reference signals (DM-RS) to aid in the estimation of the radio channel over which that REG was transmitted. When transmitting the PDCCH, a precoder could be used to apply weights at the transmit antennas based on some knowledge of the radio channel prior to transmission. It is possible to improve channel estimation performance at the UE 200 by estimating the channel over multiple REGs that are proximate in time and frequency if the precoder used at the transmitter for the REGs is not different. To assist the UE 200 with channel estimation the multiple REGs can be grouped together to form a REG bundle and the REG bundle size for a CORESET is indicated to the UE 200. The UE 200 may assume that any precoder used for the transmission of the PDCCH is the same for all the REGs in the REG bundle. A REG bundle may consist of 2, 3 or 6 REGs.

A control channel element (CCE) consists of 6 REGs. The REGs within a CCE may either be contiguous or distributed in frequency. When the REGs are distributed in frequency, the CORESET is said to be using an interleaved mapping of REGs to a CCE and if the REGs are not distributed in frequency, a non-interleaved mapping is said to be used.

Interleaving can provide frequency diversity. Not using interleaving is beneficial for cases where knowledge of the channel allows the use of a precoder in a particular part of the spectrum improve the signal-to-interference plus noise ratio (SINR) at the receiver.

A PDCCH candidate may span 1, 2, 4, 8 or 16 CCEs. If more than one CCE is used, the information in the first CCE is repeated in the other CCEs. Therefore, the number of aggregated CCEs used is referred to as the aggregation level for the PDCCH candidate.

A hashing function is used to determine the CCEs corresponding to PDCCH candidates that a UE 200 must monitor within a search space set. The hashing is done differently for different UEs so that the CCEs used by the UEs are randomized and the probability of collisions between multiple UEs for which PDCCH messages are included in a CORESET is reduced.

Slot Structure

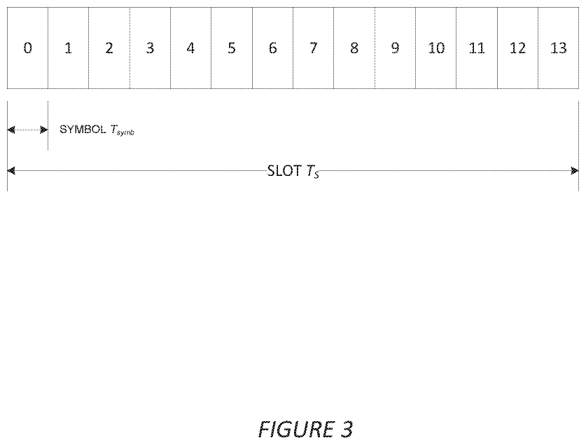

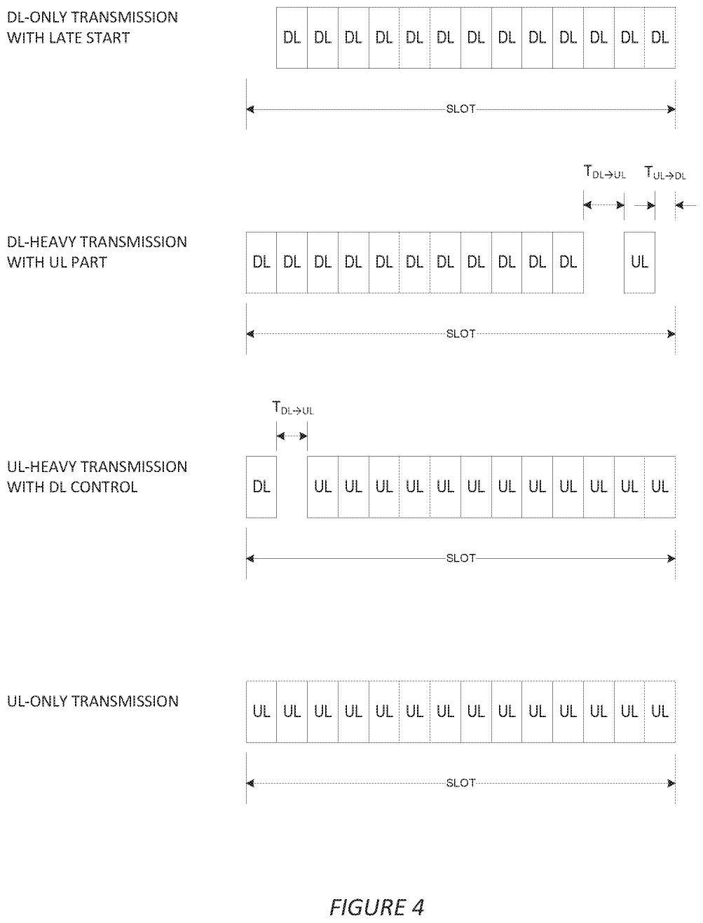

An NR slot consists of several OFDM symbols, according to current agreements either 7 or 14 symbols (OFDM subcarrier spacing≥60 kHz) or 14 symbols (OFDM subcarrier spacing>60 kHz). FIG. 3 shows a subframe with 14 OFDM symbols. In FIG. 3, T_s and T_symb denote the slot and OFDM symbol duration, respectively. In addition to a slot may also be shortened to accommodate DL/UL transient period or both DL and UL transmissions. Potential variations are shown in FIG. 4 for a slot with 14 OFDM symbols.

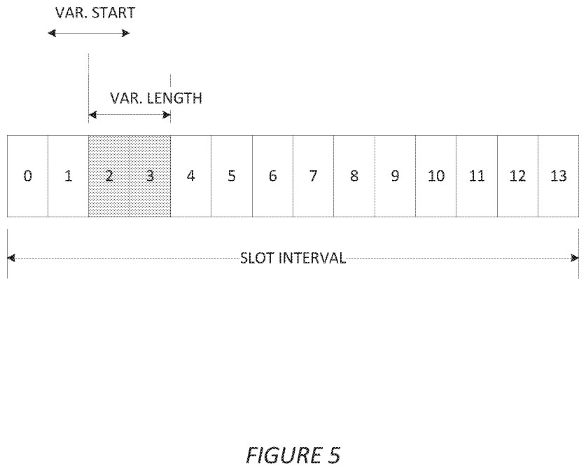

Furthermore, NR also defines Type B scheduling, also known as mini-slots. Mini-slots are shorter than slots (according to current agreements from 1 or 2 symbols up to number of symbols in a slot minus one) and can start at any symbol. Mini-slots are used if the transmission duration of a slot is too long or the occurrence of the next slot start (slot alignment) is too late. Applications of mini-slots include among others latency critical transmissions (in this case both mini-slot length and frequent opportunity of mini-slot are important) and unlicensed spectrum where a transmission should start immediately after listen-before-talk succeeded (here the frequent opportunity of mini-slot is especially important). An example of mini-slots is shown in FIG. 5.

Configured UL

NR supports two types of pre-configured resources. Both types of pre-configured resources are based on existing LTE semi-persistent scheduling with some further aspects such as supporting repetitions for a TB.

For Type 1 resources, UL data transmission with configured grant is based on RRC signaling only (e.g., (re)configuration) without any L1 signaling.

Type 2 resources are similar to the LTE semi-persistent scheduling (SPS) feature. UL data transmission with configured grant is based on both RRC configuration and Layer 1 (L1) signaling for activation/deactivation of the grant. The base station 100 needs to explicitly activate the configured resources on PDCCH and the UE 200 confirms the reception of the activation/deactivation grant with a MAC control element.

Repetition of a TB is also supported in NR, and the same resource configuration is used for K repetitions for a TB including the initial transmission. The possible values of K are {1, 2, 4, 8}. Repetitions follow an RV sequence configured by UE-specific RRC signaling to one of the following: Sequence {0, 2, 3, 1} or {0, 3, 0, 3} or {0, 0, 0, 0}.

Operation in Unlicensed Spectrum

For a UE 200 or base station 100 to be allowed to transmit in unlicensed spectrum, e.g. the 5 GHz band, it typically needs to perform a clear channel assessment (CCA). This procedure typically includes sensing the medium to be idle for a number of time intervals. Sensing the medium to be idle can be done in different ways, e.g. using energy detection, preamble detection or using virtual carrier sensing. Where the latter implies that the node reads control information from other transmitting nodes informing when a transmission ends. After sensing the medium idle a node is typically allowed to transmit for a certain amount of time, sometimes referred to as transmission opportunity (TXOP). The length of the TXOP depends on regulation and type of CCA that has been performed, but typically ranges from 1 ms to 10 ms.

The mini-slot concept in NR allows a node to access the channel at a much finer granularity compared to e.g. LTE Licensed Assistance Access (LAA), where the channel could only be accessed at 500 us intervals. Using for example 60 kHz subcarrier-spacing and a two symbol mini-slot in NR, the channel can be accessed at 36 us intervals.

Transport Block and Code Block Groups

In NR, as well as Long Term Evolution (LTE), a large transport block (TB) can be split into code blocks (CBs), each with its own cyclic redundancy check (CRC). A new feature introduced in NR is the concept of a code block group (CBG). NR allows multiple CBs to be grouped together to form a CBG and a receiving terminal can acknowledge (ACK/NACK) transmissions at the CBG level. The size of the CBG in terms of CBs can be specified by RRC signaling.

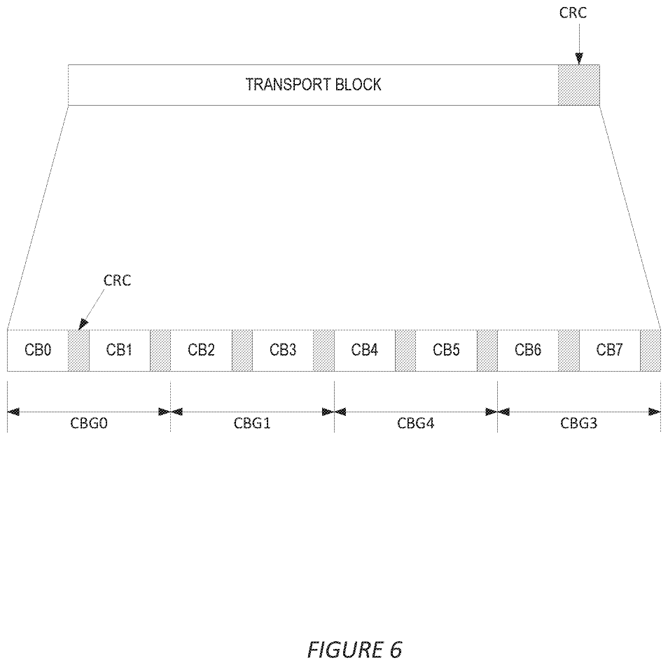

FIG. 6 illustrates an exemplary TB that has been divided into 8 CBs. The CBs are grouped into 4 CBGs, each having 2 CBs. In the case of TB-based retransmission, a single ACK/NACK is provided for the entire TB. When a TB is NACK'ed, the entire TB is retransmitted. For CBG-based retransmission, ACK/NACK signaling is provided for each of the 4 CBGs in the TB and only the NACK'ed CBGs are retransmitted. In one embodiment, the base station 100 transits a NACK if any of the CBs within the CBG are missed or incorrectly received.

One aspect of the disclosure is how to support CBG-based retransmission on configured grant resources while minimizing or reducing DL and UL control signaling related to the CBG information.

CBG-Based Retransmission on Configured UL Resources

Downlink Feedback Information (DFI) is control information sent as a DCI via PDCCH and includes at least HARQ feedback for configured grant (CG) transmissions. CG uplink control information (CG-UCI) is control information that is carried on every CG-PUSCH. To support CBG-based retransmission, DFI is transmitted by the base station 100 to the UE 200 as DCI on the PDCCH. In one embodiment, the DFI comprises TB-level feedback, retransmission control information, and CBG-level feedback.

The TB-level feedback provides, for each HARQ process (also referred to as an acknowledgement process), TB-level feedback indicating an acknowledgement (ACK) or negative acknowledgement (NACK) of a TB associated with the HARQ process. The TB-level feedback can be sent in the form of a TB-level bitmap having one or more bits mapped to some or all the UL HARQ processes configured on that cell. The TB-level bitmap provides TB-level bit acknowledgement for a TB corresponding to each HARQ process. As one example, a 0 is used in the TB-level bitmap to indicate a negative acknowledgement (NACK) of a TB and a 1 is used to indicate an acknowledgement (ACK), or vice versa. The TB-level bitmap may also encompass the UL HARQ processes configured on multiple UL cells. In one embodiment, the TB-level feedback for a HARQ process is set to NACK if at least one of the CBs of the TB is NACK.

The retransmission control information indicates, for each negatively acknowledged TB, whether the base station 100 expects retransmission at the TB level or a CBG level. The retransmission control information can be provided in the form of a CBG-indicator bitmap mapped to all TBs that have been NACK'ed. In one embodiment, a 0 indicates TB-based retransmission is expected from the UE 200 and a 1 indicates that UE 200 may perform CBG-based retransmission, or vice versa. For instance, if the TB-level bit map indicates {00101110100110} where 0 indicates a NACK, the bit width of CBG indicator bitmap is 7 bits.

The CBG-level feedback, also referred to as CBG transmission information (CBGTI), provides, for one or more negatively acknowledged TBs where the CBG-indicator bitmap indicates CBG-level retransmission, an acknowledgement (ACK) or negative acknowledgement (NACK) for one or more CBGs in the TB. That is, the CBG-level feedback is provided for each NACK'ed TB where the corresponding CBG-indicator is set to true. For every NACK'ed TB with the CGB-indicator set to true, the UE 200 expects CBG-level feedback information. For instance if the TB-level bit map indicates {00101110100110} and the CBG-indicator indicates {0110000}, the UE 200 expects CBG-level feedback for two HARQ processes. In one embodiment, the CBG-level indicates the feedback (ACK or NACK) for each CBG in a TB where at least one CB is NACK'ed. In another embodiment, the CBG-level indicates the feedback for each CBG of the TB in which all, or a predetermined number of, CBs is NACK'ed.

Even with the variable CBG-indicator bitmap length and CBG transmission information, it is up to the base station 100 to guarantee that the length of the DFI matches other DCI lengths (the length of UL or DL scheduling DCI(s)). If the length does not match, zero-padding is used to align the DCI sizes.

UE Operation

The UE 200 is allowed to perform CBG-based retransmission only if it receives CGB indication via the DFI (i.e., the CBG-indicator for the HARQ process is set to true). In response to timer expiration (i.e., timer expires and no feedback was received), the UE 200 is expected to perform TB-based retransmission. The UE 200 cannot autonomously select a CBG for retransmissions other than the ones explicitly indicated by the base station 100 via DFI. In some embodiments, the UE 200 signals the retransmission scheme (e.g., TB-based or CBG-based) to the base station 100 to enable the base station 100 to differentiate between TB-based retransmission and CBG-based retransmission. In one embodiment, the UE 200 signals the retransmission scheme by sending one bit via CG-UCI. For instance, the UE 200 can send a 0 to indicate TB-level transmission and a 1 to indicate CBG-based retransmission. The CG-UCI thus enables the UE 200 to select TB-based retransmission even where the CBG-indicator indicates that CBG-level retransmission is allowed. In other embodiments, the UE 200 must use CBG-level retransmission when indicated by the base station 100.

For a CBG-based retransmission, the UE 200 rate matches the retransmission to fit on the available number of CG-resources. The CBG-based retransmission does not need to necessarily take the same number of resources as the initial transmission. If multiple CG configurations are activated, the UE 200 may send CBG-based retransmission on a configuration different than the one used for initial transmission and possibly with less number of CG-resources.

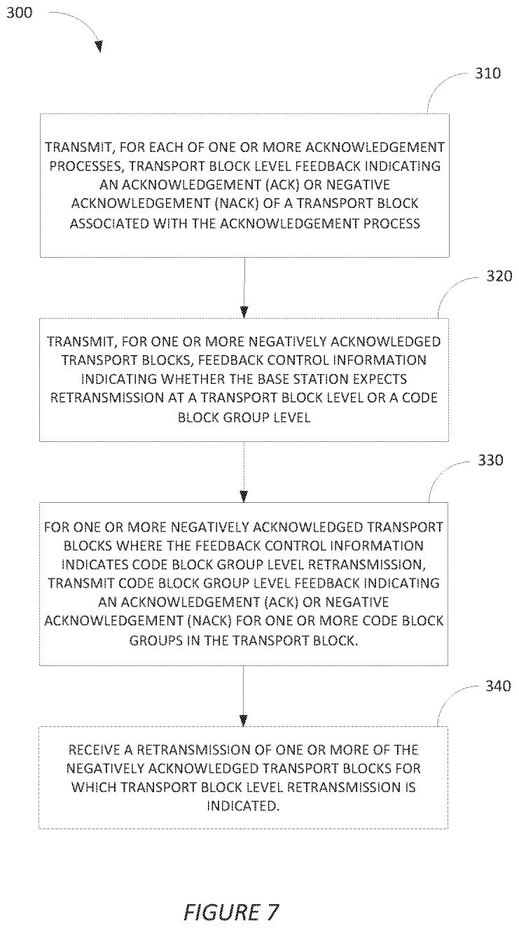

FIG. 7 illustrates an exemplary method 300 performed by a base station 100 to support CBG retransmission for configured resources. The base station 100 transmits, for each of one or more acknowledgement processes, TB-level feedback indicating either an acknowledgement (ACK) or negative acknowledgement (NACK) of a TB associated with the acknowledgement process (block 310). The base station 100 also transmits, for one or more negatively acknowledged TBs, retransmission control information indicating whether the base station 100 expects retransmission at the TB level or CBG level (block 320). For one or more negatively acknowledged TBs where the CBG-level retransmission is indicated by the retransmission control information, the base station 100 transmits CBG-level feedback indicating either an acknowledgement (ACK) or negative acknowledgement (NACK) for each of one or more CBGs in the TB (block 330). Some embodiments of the method 300 further comprise receiving uplink control information indicating whether a retransmission is a CBG-based retransmission of a TB-based retransmission (block 340).

In some embodiments of the method 300, transmitting TB-level feedback comprises transmitting a first bitmap where each bit indicates the acknowledgement (ACK) or negative acknowledgement (NACK) of a respective TB associated with one of the acknowledgement processes.

In some embodiments of the method 300, transmitting retransmission control information comprises transmitting a second bitmap where each bit indicates either TB-level retransmission or CBG-level retransmission for a respective one of the negatively acknowledged TBs.

In some embodiments of the method 300, transmitting CBG-level feedback comprises transmitting a third bitmap corresponding to one of the negatively acknowledged TBs where each bit represents an acknowledgement (ACK) or negative acknowledgement (NACK) of a respective CBG in the negatively acknowledged TB.

Some embodiments of the method 300 further comprise receiving a retransmission of one or more of the negatively acknowledged CBGs in one of the TBs for which transport level retransmission is indicated.

Some embodiments of the method 300 further comprise receiving a retransmission of one or more of the negatively acknowledged TBs for which transport level retransmission is indicated.

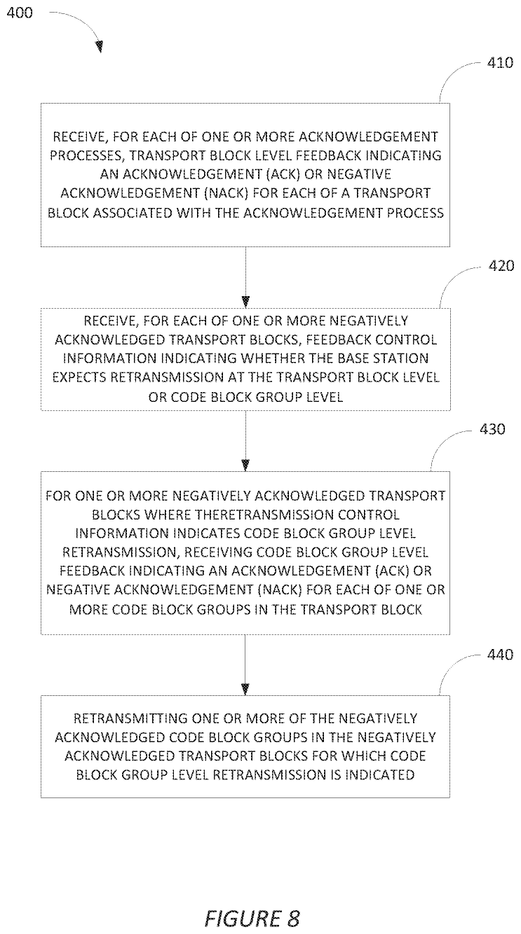

FIG. 8 illustrates an exemplary method 400 performed by a UE 200 of CBG-level retransmission on configured resources. The UE 200 receives, for each of one or more acknowledgement processes, TB-level feedback indicating an acknowledgement (ACK) or negative acknowledgement (NACK) of a TB associated with the acknowledgement process (block 410). The UE 200 also receives, for each of one or more negatively acknowledged TBs, retransmission control information indicating whether the base station expects retransmission at the TB level or CBG level (block 420). For one or more negatively acknowledged TBs where the CBG-level retransmission is indicated by the retransmission control information, the UE 200 receives CBG-level feedback indicating an acknowledgement (ACK) or negative acknowledgement (NACK) for each of one or more CBGs in the TB (block 430). In response to the negative acknowledgement (NACK) of a CBG, the UE 200 retransmits the negatively acknowledged CBGs in the negatively acknowledged TBs for which CBG-level retransmission is indicated (block 440).

In some embodiments of the method 400, receiving TB-level feedback comprises receiving a first bitmap where each bit indicates the acknowledgement (ACK) or negative acknowledgement (NACK) of a respective TB associated with one of the acknowledgement processes.

In some embodiments of the method 400, receiving retransmission control information comprises receiving a second bitmap where each bit indicates either TB-level retransmission or CBG-level retransmission for a respective one of the negatively acknowledged TBs.

In some embodiments of the method 400, receiving CBG-level feedback comprises receiving a third bitmap corresponding to one of the negatively acknowledged TBs where each bit represents an acknowledgement (ACK) or negative acknowledgement (NACK) of a respective CBG in the negatively acknowledged TB.

Some embodiments of the method 400 further comprise retransmitting one or more of the negatively acknowledged TBs for which TB-level retransmission is indicated.

In some embodiments of the method 400, receiving TB-level feedback comprises receiving an acknowledgement (ACK) in the case where all CBGs in the TB are successfully received, and receiving a negative acknowledgement (NACK) in the case where all CBGs in the TB are not successfully received.

Some embodiments of the method 400 further comprise transmitting uplink control information to the base station indicating whether a retransmission is a CBG-based retransmission of a TB-based retransmission.

Some embodiments of the method 400 further comprise rate matching a CBG-based retransmission to fit an available number of CG resources.

An apparatus can perform any of the methods herein described by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include Digital Signal Processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

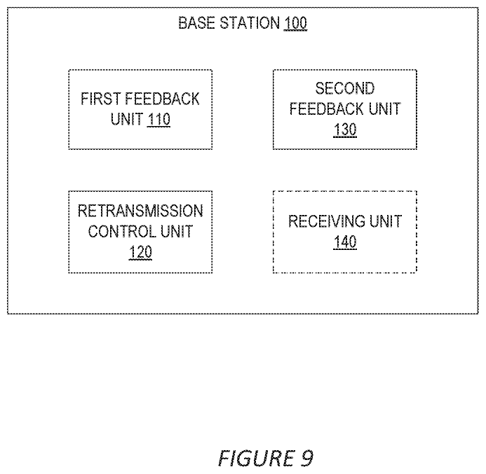

FIG. 9 illustrates a base station 100 in accordance with one or more embodiments. The base station 100 comprises a first feedback unit 110, a retransmission control unit 120, a second feedback unit 130, and an optional receiving unit 140. The various units 110-140 can be implemented by hardware and/or by software code that is executed by a processor or processing circuit. The first feedback unit 110 is configured to transmit, for each of one or more acknowledgement processes, TB-level feedback indicating an acknowledgement (ACK) or negative acknowledgement (NACK) for a TB associated with the acknowledgement process. The retransmission control unit 120 is configured to transmit, for one or more negatively acknowledged TBs, retransmission control information indicating whether the base station expects retransmission at a TB level or a CBG level The second feedback unit 130 is configured to transmit, for one or more negatively acknowledged TBs where the retransmission control information indicates CBG-level retransmission, CBG-level feedback indicating an acknowledgement (ACK) or negative acknowledgement (NACK) for one or more CBGs in the TB. The receiving unit 140, when present, is configured to receive retransmission of one or more of the negatively acknowledged CBGs in the one or more negatively acknowledged TBs for which CBG-level retransmission is indicated.

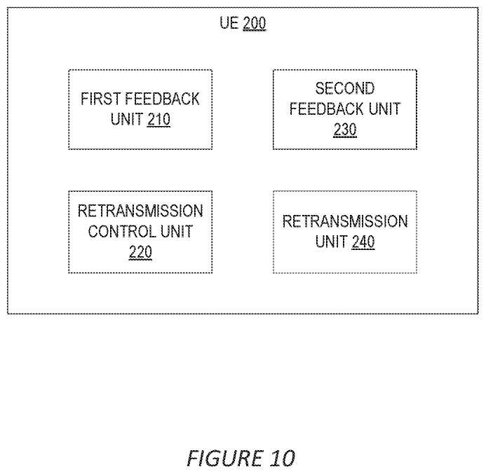

FIG. 10 illustrates a UE 200 in accordance with one or more embodiments. The UE 200 comprises a first feedback unit 210, a retransmission control unit 220, a second feedback unit 230, and a retransmission unit 240. The various units 210-240 can be implemented by hardware and/or by software code that is executed by one or more processors or processing circuits. The first feedback unit 210 is configured to receive, for each of one or more acknowledgement processes, TB-level feedback indicating an acknowledgement (ACK) or negative acknowledgement (NACK) of a TB associated with the acknowledgement process. The retransmission control unit 22 is configured to receive, for each of one or more negatively acknowledged TBs, retransmission control information indicating whether the base station expects retransmission at the TB level or CBG level. The second feedback unit 230 is configured to receive, for one or more negatively acknowledged TBs where CBG-level retransmission is indicated by the retransmission control information, CBG-level feedback indicating an acknowledgement (ACK) or negative acknowledgement (NACK) for each of one or more CBGs in the TB The retransmission unit 240 is configured to retransmit one or more of the negatively acknowledged CBGs in the negatively acknowledged TBs for which CBG-level retransmission is indicated.

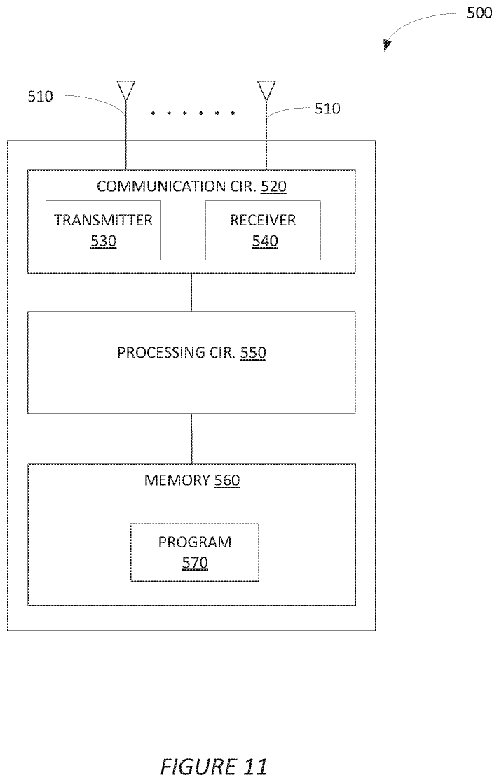

FIG. 11 illustrates a base station 500 according to one embodiment. The base station 500 comprises one or more antennas elements 510, a communication circuitry 520, a processing circuitry 550, and memory 560.

The communication circuitry circuit 520 is coupled to the antennas 510 and comprises the radio frequency (RF) circuitry needed for transmitting and receiving signals over a wireless communication channel. The RF circuitry comprises a transmitter 530 and receiver 540 configured to operate, for example, according to the NR standard.

The processing circuitry 550 controls the overall operation of the base station 500 and processes the signals transmitted to or received by the base station 500. Such processing includes providing HARQ feedback and controlling retransmission on the uplink to support CBG-level retransmission on configured resources on the uplink. In one embodiment, the processing circuitry is configured to perform the method 300 of FIG. 7.

Memory 560 comprises both volatile and non-volatile memory for storing computer program code and data needed by the processing circuitry 550 for operation. Memory 560 may comprise any tangible, non-transitory computer-readable storage medium for storing data including electronic, magnetic, optical, electromagnetic, or semiconductor data storage. Memory 560 stores a computer program 570 comprising executable instructions that configure the processing circuitry 550 to implement the methods 300 according to FIG. 7 as described herein. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 570 for configuring the processing circuitry 550 as herein described may be stored in a removable memory, such as a portable compact disc, portable digital video disc, or other removable media. The computer program 570 may also be embodied in a carrier such as an electronic signal, optical signal, radio signal, or computer readable storage medium.

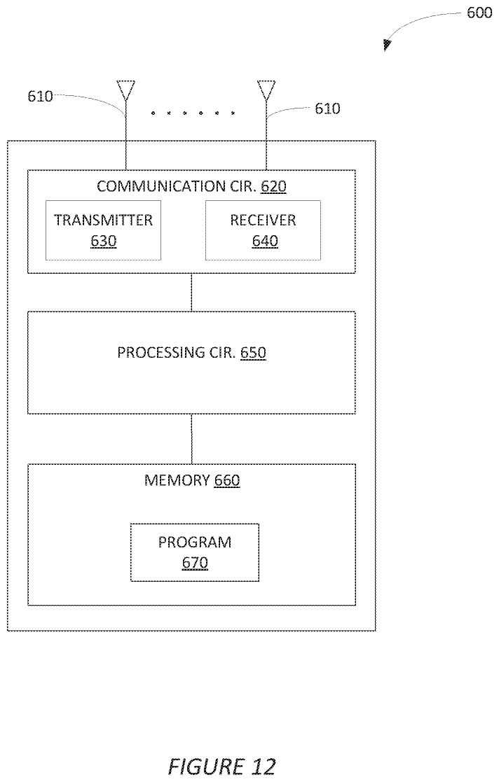

FIG. 12 illustrates a UE 600 according to one embodiment. The UE 600 comprises one or more antennas elements 610, a communication circuitry 620, a processing circuitry 650, and memory 660.

The communication circuitry circuit 620 is coupled to the antennas 610 and comprises the radio frequency (RF) circuitry needed for transmitting and receiving signals over a wireless communication channel. The RF circuitry comprises a transmitter 630 and receiver 640 configured to operate, for example, according to the NR standard.

The processing circuitry 650 controls the overall operation of the UE 600 and processes the signals transmitted to or received by the UE 600. Such processing includes processing HARQ feedback and controlling retransmission on the uplink to support CBG-level retransmission on configured resources on the uplink. In one embodiment, the processing circuitry is configured to perform the method 400 of FIG. 8.

Memory 660 comprises both volatile and non-volatile memory for storing computer program code and data needed by the processing circuitry 650 for operation. Memory 660 may comprise any tangible, non-transitory computer-readable storage medium for storing data including electronic, magnetic, optical, electromagnetic, or semiconductor data storage. Memory 660 stores a computer program 670 comprising executable instructions that configure the processing circuitry 650 to implement the methods 400 according to FIG. 8 as described herein. A computer program in this regard may comprise one or more code modules corresponding to the means or units described above. In general, computer program instructions and configuration information are stored in a non-volatile memory, such as a ROM, erasable programmable read only memory (EPROM) or flash memory. Temporary data generated during operation may be stored in a volatile memory, such as a random access memory (RAM). In some embodiments, computer program 670 for configuring the processing circuitry 650 as herein described may be stored in a removable memory, such as a portable compact disc, portable digital video disc, or other removable media. The computer program 670 may also be embodied in a carrier such as an electronic signal, optical signal, radio signal, or computer readable storage medium.

Those skilled in the art will also appreciate that embodiments herein further include corresponding computer programs. A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

### Additional Embodiments

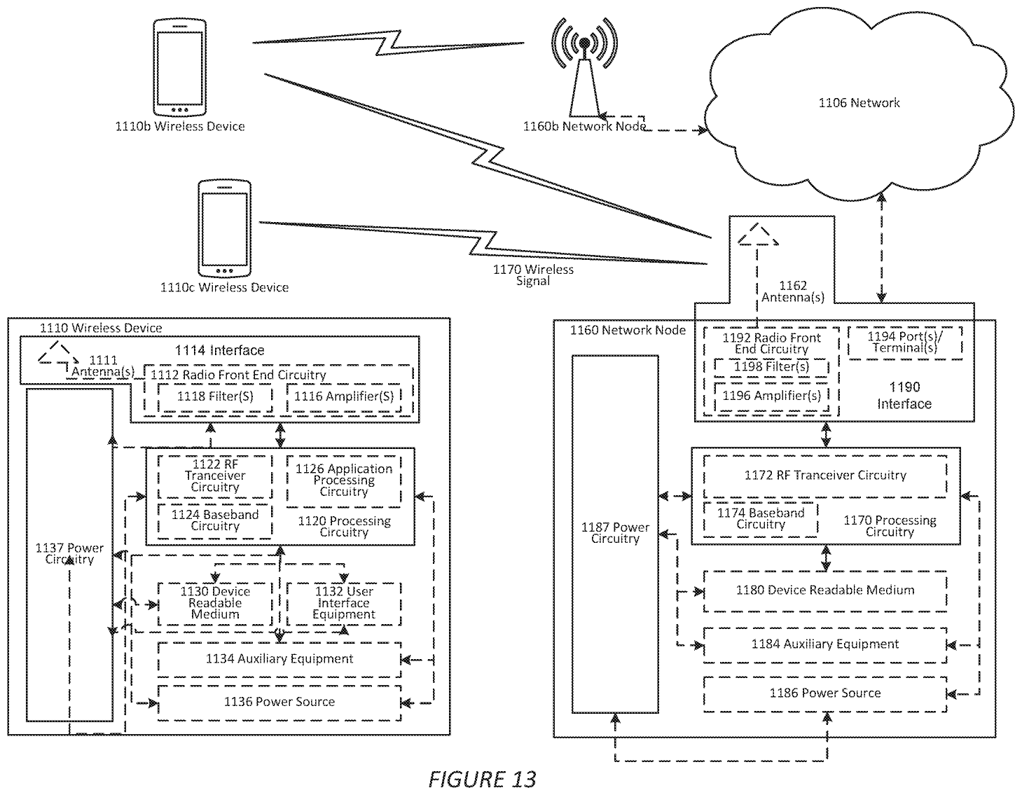

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1106, network nodes 1160 and 1160b, and WDs 1110, 1110b, and 1110c. In practice, a wireless network may further include any additional elements suitable to support communication between wireless devices or between a wireless device and another communication device, such as a landline telephone, a service provider, or any other network node or end device. Of the illustrated components, network node 1160 and wireless device (WD) 1110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1160 and WD 1110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), and base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1160 includes processing circuitry 1170, device readable medium 1180, interface 1190, auxiliary equipment 1184, power source 1186, power circuitry 1187, and antenna 1162. Although network node 1160 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1160 are depicted as single boxes located within a larger box, or nested within multiple boxes, in practice, a network node may comprise multiple different physical components that make up a single illustrated component (e.g., device readable medium 1180 may comprise multiple separate hard drives as well as multiple RAM modules).

Similarly, network node 1160 may be composed of multiple physically separate components (e.g., a NodeB component and a RNC component, or a BTS component and a BSC component, etc.), which may each have their own respective components. In certain scenarios in which network node 1160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1160 may be configured to support multiple radio access technologies (RATs). In such embodiments, some components may be duplicated (e.g., separate device readable medium 1180 for the different RATs) and some components may be reused (e.g., the same antenna 1162 may be shared by the RATs). Network node 1160 may also include multiple sets of the various illustrated components for different wireless technologies integrated into network node 1160, such as, for example, GSM, WCDMA, LTE, NR, WiFi, or Bluetooth wireless technologies. These wireless technologies may be integrated into the same or different chip or set of chips and other components within network node 1160.

Processing circuitry 1170 is configured to perform any determining, calculating, or similar operations (e.g., certain obtaining operations) described herein as being provided by a network node. These operations performed by processing circuitry 1170 may include processing information obtained by processing circuitry 1170 by, for example, converting the obtained information into other information, comparing the obtained information or converted information to information stored in the network node, and/or performing one or more operations based on the obtained information or converted information, and as a result of said processing making a determination.

Processing circuitry 1170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1160 components, such as device readable medium 1180, network node 1160 functionality. For example, processing circuitry 1170 may execute instructions stored in device readable medium 1180 or in memory within processing circuitry 1170. Such functionality may include providing any of the various wireless features, functions, or benefits discussed herein. In some embodiments, processing circuitry 1170 may include a system on a chip (SOC).

In some embodiments, processing circuitry 1170 may include one or more of radio frequency (RF) transceiver circuitry 1172 and baseband processing circuitry 1174. In some embodiments, radio frequency (RF) transceiver circuitry 1172 and baseband processing circuitry 1174 may be on separate chips (or sets of chips), boards, or units, such as radio units and digital units. In alternative embodiments, part or all of RF transceiver circuitry 1172 and baseband processing circuitry 1174 may be on the same chip or set of chips, boards, or units.

In certain embodiments, some or all of the functionality described herein as being provided by a network node, base station, eNB or other such network device may be performed by processing circuitry 1170 executing instructions stored on device readable medium 1180 or memory within processing circuitry 1170. In alternative embodiments, some or all of the functionality may be provided by processing circuitry 1170 without executing instructions stored on a separate or discrete device readable medium, such as in a hard-wired manner. In any of those embodiments, whether executing instructions stored on a device readable storage medium or not, processing circuitry 1170 can be configured to perform the described functionality. The benefits provided by such functionality are not limited to processing circuitry 1170 alone or to other components of network node 1160, but are enjoyed by network node 1160 as a whole, and/or by end users and the wireless network generally.

Device readable medium 1180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1170. Device readable medium 1180 may store any suitable instructions, data or information, including a computer program, software, an application including one or more of logic, rules, code, tables, etc. and/or other instructions capable of being executed by processing circuitry 1170 and, utilized by network node 1160. Device readable medium 1180 may be used to store any calculations made by processing circuitry 1170 and/or any data received via interface 1190. In some embodiments, processing circuitry 1170 and device readable medium 1180 may be considered to be integrated.

Interface 1190 is used in the wired or wireless communication of signaling and/or data between network node 1160, network 1106, and/or WDs 1110. As illustrated, interface 1190 comprises port(s)/terminal(s) 1194 to send and receive data, for example to and from network 1106 over a wired connection. Interface 1190 also includes radio front end circuitry 1192 that may be coupled to, or in certain embodiments a part of, antenna 1162. Radio front end circuitry 1192 comprises filters 1198 and amplifiers 1196. Radio front end circuitry 1192 may be connected to antenna 1162 and processing circuitry 1170. Radio front end circuitry may be configured to condition signals communicated between antenna 1162 and processing circuitry 1170. Radio front end circuitry 1192 may receive digital data that is to be sent out to other network nodes or WDs via a wireless connection. Radio front end circuitry 1192 may convert the digital data into a radio signal having the appropriate channel and bandwidth parameters using a combination of filters 1198 and/or amplifiers 1196. The radio signal may then be transmitted via antenna 1162. Similarly, when receiving data, antenna 1162 may collect radio signals which are then converted into digital data by radio front end circuitry 1192. The digital data may be passed to processing circuitry 1170. In other embodiments, the interface may comprise different components and/or different combinations of components.

In certain alternative embodiments, network node 1160 may not include separate radio front end circuitry 1192, instead, processing circuitry 1170 may comprise radio front end circuitry and may be connected to antenna 1162 without separate radio front end circuitry 1192. Similarly, in some embodiments, all or some of RF transceiver circuitry 1172 may be considered a part of interface 1190. In still other embodiments, interface 1190 may include one or more ports or terminals 1194, radio front end circuitry 1192, and RF transceiver circuitry 1172, as part of a radio unit (not shown), and interface 1190 may communicate with baseband processing circuitry 1174, which is part of a digital unit (not shown).

Antenna 1162 may include one or more antennas, or antenna arrays, configured to send and/or receive wireless signals. Antenna 1162 may be coupled to radio front end circuitry 1190 and may be any type of antenna capable of transmitting and receiving data and/or signals wirelessly. In some embodiments, antenna 1162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1162 may be separate from network node 1160 and may be connectable to network node 1160 through an interface or port.

Antenna 1162, interface 1190, and/or processing circuitry 1170 may be configured to perform any receiving operations and/or certain obtaining operations described herein as being performed by a network node. Any information, data and/or signals may be received from a wireless device, another network node and/or any other network equipment. Similarly, antenna 1162, interface 1190, and/or processing circuitry 1170 may be configured to perform any transmitting operations described herein as being performed by a network node. Any information, data and/or signals may be transmitted to a wireless device, another network node and/or any other network equipment.

Power circuitry 1187 may comprise, or be coupled to, power management circuitry and is configured to supply the components of network node 1160 with power for performing the functionality described herein. Power circuitry 1187 may receive power from power source 1186. Power source 1186 and/or power circuitry 1187 may be configured to provide power to the various components of network node 1160 in a form suitable for the respective components (e.g., at a voltage and current level needed for each respective component). Power source 1186 may either be included in, or external to, power circuitry 1187 and/or network node 1160. For example, network node 1160 may be connectable to an external power source (e.g., an electricity outlet) via an input circuitry or interface such as an electrical cable, whereby the external power source supplies power to power circuitry 1187. As a further example, power source 1186 may comprise a source of power in the form of a battery or battery pack which is connected to, or integrated in, power circuitry 1187. The battery may provide backup power should the external power source fail. Other types of power sources, such as photovoltaic devices, may also be used.

Alternative embodiments of network node 1160 may include additional components beyond those shown in FIG. 13 that may be responsible for providing certain aspects of the network node's functionality, including any of the functionality described herein and/or any functionality necessary to support the subject matter described herein. For example, network node 1160 may include user interface equipment to allow input of information into network node 1160 and to allow output of information from network node 1160. This may allow a user to perform diagnostic, maintenance, repair, and other administrative functions for network node 1160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1110 includes antenna 1111, interface 1114, processing circuitry 1120, device readable medium 1130, user interface equipment 1132, auxiliary equipment 1134, power source 1136 and power circuitry 1137. WD 1110 may include multiple sets of one or more of the illustrated components for different wireless technologies supported by WD 1110, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1110. Antenna 1111 may include one or more antennas or antenna arrays, configured to send and/or receive wireless signals, and is connected to interface 1114. In certain alternative embodiments, antenna 1111 may be separate from WD 1110 and be connectable to WD 1110 through an interface or port. Antenna 1111, interface 1114, and/or processing circuitry 1120 may be configured to perform any receiving or transmitting operations described herein as being performed by a WD. Any information, data and/or signals may be received from a network node and/or another WD. In some embodiments, radio front end circuitry and/or antenna 1111 may be considered an interface.

As illustrated, interface 1114 comprises radio front end circuitry 1112 and antenna 1111. Radio front end circuitry 1112 comprise one or more filters 1118 and amplifiers 1116. Radio front end circuitry 1114 is connected to antenna 1111 and processing circuitry 1120, and is configured to condition signals communicated between antenna 1111 and processing circuitry 1120. Radio front end circuitry 1112 may be coupled to or a part of antenna 1111. In some embodiments, WD 1110 may not include separate radio front end circuitry 1112; rather, processing circuitry 1120 may comprise radio front end circuitry and may be connected to antenna 1111. Similarly, in some embodiments, some or all of RF transceiver circuitry 1122 may be considered a part of interface 1114. Radio front end circuitry 1112 may receive digital data that is to be sent out to other network nodes or WDs via a wireless connection. Radio front end circuitry 1112 may convert the digital data into a radio signal having the appropriate channel and bandwidth parameters using a combination of filters 1118 and/or amplifiers 1116. The radio signal may then be transmitted via antenna 1111. Similarly, when receiving data, antenna 1111 may collect radio signals which are then converted into digital data by radio front end circuitry 1112. The digital data may be passed to processing circuitry 1120. In other embodiments, the interface may comprise different components and/or different combinations of components.

Processing circuitry 1120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1110 components, such as device readable medium 1130, WD 1110 functionality. Such functionality may include providing any of the various wireless features or benefits discussed herein. For example, processing circuitry 1120 may execute instructions stored in device readable medium 1130 or in memory within processing circuitry 1120 to provide the functionality disclosed herein.

As illustrated, processing circuitry 1120 includes one or more of RF transceiver circuitry 1122, baseband processing circuitry 1124, and application processing circuitry 1126. In other embodiments, the processing circuitry may comprise different components and/or different combinations of components. In certain embodiments processing circuitry 1120 of WD 1110 may comprise a SOC. In some embodiments, RF transceiver circuitry 1122, baseband processing circuitry 1124, and application processing circuitry 1126 may be on separate chips or sets of chips. In alternative embodiments, part or all of baseband processing circuitry 1124 and application processing circuitry 1126 may be combined into one chip or set of chips, and RF transceiver circuitry 1122 may be on a separate chip or set of chips. In still alternative embodiments, part or all of RF transceiver circuitry 1122 and baseband processing circuitry 1124 may be on the same chip or set of chips, and application processing circuitry 1126 may be on a separate chip or set of chips. In yet other alternative embodiments, part or all of RF transceiver circuitry 1122, baseband processing circuitry 1124, and application processing circuitry 1126 may be combined in the same chip or set of chips. In some embodiments, RF transceiver circuitry 1122 may be a part of interface 1114. RF transceiver circuitry 1122 may condition RF signals for processing circuitry 1120.

In certain embodiments, some or all of the functionality described herein as being performed by a WD may be provided by processing circuitry 1120 executing instructions stored on device readable medium 1130, which in certain embodiments may be a computer-readable storage medium. In alternative embodiments, some or all of the functionality may be provided by processing circuitry 1120 without executing instructions stored on a separate or discrete device readable storage medium, such as in a hard-wired manner. In any of those particular embodiments, whether executing instructions stored on a device readable storage medium or not, processing circuitry 1120 can be configured to perform the described functionality. The benefits provided by such functionality are not limited to processing circuitry 1120 alone or to other components of WD 1110, but are enjoyed by WD 1110 as a whole, and/or by end users and the wireless network generally.

Processing circuitry 1120 may be configured to perform any determining, calculating, or similar operations (e.g., certain obtaining operations) described herein as being performed by a WD. These operations, as performed by processing circuitry 1120, may include processing information obtained by processing circuitry 1120 by, for example, converting the obtained information into other information, comparing the obtained information or converted information to information stored by WD 1110, and/or performing one or more operations based on the obtained information or converted information, and as a result of said processing making a determination.

Device readable medium 1130 may be operable to store a computer program, software, an application including one or more of logic, rules, code, tables, etc. and/or other instructions capable of being executed by processing circuitry 1120. Device readable medium 1130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1120. In some embodiments, processing circuitry 1120 and device readable medium 1130 may be considered to be integrated.

User interface equipment 1132 may provide components that allow for a human user to interact with WD 1110. Such interaction may be of many forms, such as visual, audial, tactile, etc. User interface equipment 1132 may be operable to produce output to the user and to allow the user to provide input to WD 1110. The type of interaction may vary depending on the type of user interface equipment 1132 installed in WD 1110. For example, if WD 1110 is a smart phone, the interaction may be via a touch screen; if WD 1110 is a smart meter, the interaction may be through a screen that provides usage (e.g., the number of gallons used) or a speaker that provides an audible alert (e.g., if smoke is detected). User interface equipment 1132 may include input interfaces, devices and circuits, and output interfaces, devices and circuits. User interface equipment 1132 is configured to allow input of information into WD 1110, and is connected to processing circuitry 1120 to allow processing circuitry 1120 to process the input information. User interface equipment 1132 may include, for example, a microphone, a proximity or other sensor, keys/buttons, a touch display, one or more cameras, a USB port, or other input circuitry. User interface equipment 1132 is also configured to allow output of information from WD 1110, and to allow processing circuitry 1120 to output information from WD 1110. User interface equipment 1132 may include, for example, a speaker, a display, vibrating circuitry, a USB port, a headphone interface, or other output circuitry. Using one or more input and output interfaces, devices, and circuits, of user interface equipment 1132, WD 1110 may communicate with end users and/or the wireless network, and allow them to benefit from the functionality described herein.

Auxiliary equipment 1134 is operable to provide more specific functionality which may not be generally performed by WDs. This may comprise specialized sensors for doing measurements for various purposes, interfaces for additional types of communication such as wired communications etc. The inclusion and type of components of auxiliary equipment 1134 may vary depending on the embodiment and/or scenario.

Power source 1136 may, in some embodiments, be in the form of a battery or battery pack. Other types of power sources, such as an external power source (e.g., an electricity outlet), photovoltaic devices or power cells, may also be used. WD 1110 may further comprise power circuitry 1137 for delivering power from power source 1136 to the various parts of WD 1110 which need power from power source 1136 to carry out any functionality described or indicated herein. Power circuitry 1137 may in certain embodiments comprise power management circuitry. Power circuitry 1137 may additionally or alternatively be operable to receive power from an external power source; in which case WD 1110 may be connectable to the external power source (such as an electricity outlet) via input circuitry or an interface such as an electrical power cable. Power circuitry 1137 may also in certain embodiments be operable to deliver power from an external power source to power source 1136. This may be, for example, for the charging of power source 1136. Power circuitry 1137 may perform any formatting, converting, or other modification to the power from power source 1136 to make the power suitable for the respective components of WD 1110 to which power is supplied.

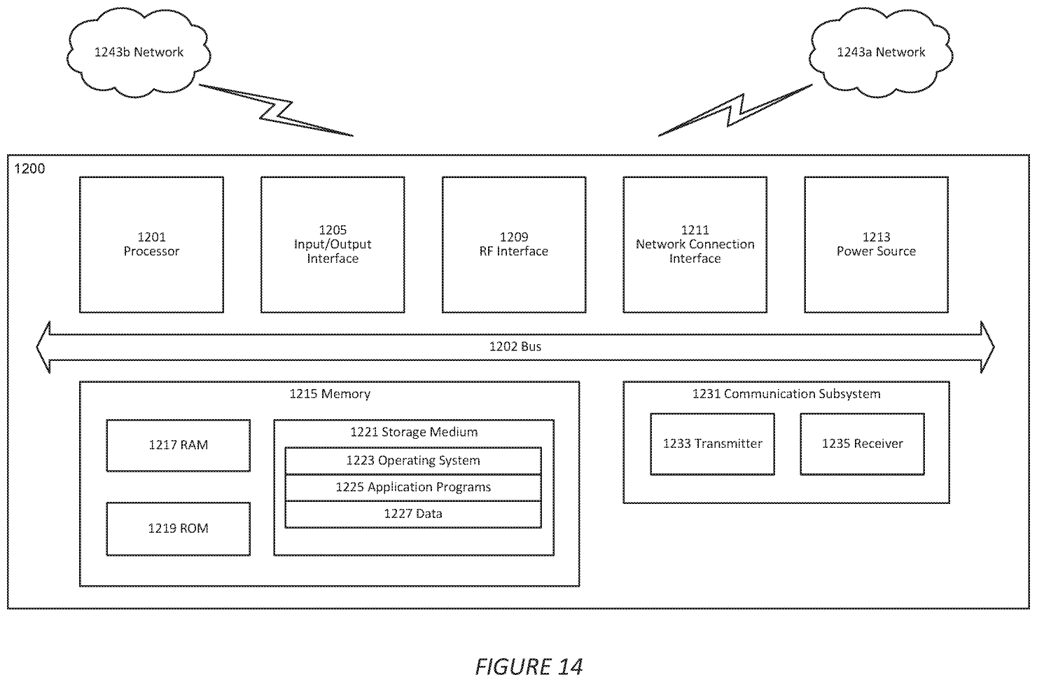

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1200 may be any UE identified by the 3rd Generation Partnership Project (3GPP), including a NB-IoT UE, a machine type communication (MTC) UE, and/or an enhanced MTC (eMTC) UE. UE 1200, as illustrated in FIG. 14, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1200 includes processing circuitry 1201 that is operatively coupled to input/output interface 1205, radio frequency (RF) interface 1209, network connection interface 1211, memory 1215 including random access memory (RAM) 1217, read-only memory (ROM) 1219, and storage medium 1221 or the like, communication subsystem 1231, power source 1233, and/or any other component, or any combination thereof. Storage medium 1221 includes operating system 1223, application program 1225, and data 1227. In other embodiments, storage medium 1221 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1201 may be configured to process computer instructions and data. Processing circuitry 1201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1201 may include two central processing units (CPUs). Data may be information in a form suitable for use by a computer.

In the depicted embodiment, input/output interface 1205 may be configured to provide a communication interface to an input device, output device, or input and output device. UE 1200 may be configured to use an output device via input/output interface 1205. An output device may use the same type of interface port as an input device. For example, a USB port may be used to provide input to and output from UE 1200. The output device may be a speaker, a sound card, a video card, a display, a monitor, a printer, an actuator, an emitter, a smartcard, another output device, or any combination thereof. UE 1200 may be configured to use an input device via input/output interface 1205 to allow a user to capture information into UE 1200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1209 may be configured to provide a communication interface to RF components such as a transmitter, a receiver, and an antenna. Network connection interface 1211 may be configured to provide a communication interface to network 1243a. Network 1243a may encompass wired and/or wireless networks such as a local-area network (LAN), a wide-area network (WAN), a computer network, a wireless network, a telecommunications network, another like network or any combination thereof. For example, network 1243a may comprise a Wi-Fi network. Network connection interface 1211 may be configured to include a receiver and a transmitter interface used to communicate with one or more other devices over a communication network according to one or more communication protocols, such as Ethernet, TCP/IP, SONET, ATM, or the like. Network connection interface 1211 may implement receiver and transmitter functionality appropriate to the communication network links (e.g., optical, electrical, and the like). The transmitter and receiver functions may share circuit components, software or firmware, or alternatively may be implemented separately.

RAM 1217 may be configured to interface via bus 1202 to processing circuitry 1201 to provide storage or caching of data or computer instructions during the execution of software programs such as the operating system, application programs, and device drivers. ROM 1219 may be configured to provide computer instructions or data to processing circuitry 1201. For example, ROM 1219 may be configured to store invariant low-level system code or data for basic system functions such as basic input and output (I/O), startup, or reception of keystrokes from a keyboard that are stored in a non-volatile memory. Storage medium 1221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1221 may be configured to include operating system 1223, application program 1225 such as a web browser application, a widget or gadget engine or another application, and data file 1227. Storage medium 1221 may store, for use by UE 1200, any of a variety of various operating systems or combinations of operating systems.

Storage medium 1221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1221 may allow UE 1200 to access computer-executable instructions, application programs or the like, stored on transitory or non-transitory memory media, to off-load data, or to upload data. An article of manufacture, such as one utilizing a communication system may be tangibly embodied in storage medium 1221, which may comprise a device readable medium.

In FIG. 14, processing circuitry 1201 may be configured to communicate with network 1243b using communication subsystem 1231. Network 1243a and network 1243b may be the same network or networks or different network or networks. Communication subsystem 1231 may be configured to include one or more transceivers used to communicate with network 1243b. For example, communication subsystem 1231 may be configured to include one or more transceivers used to communicate with one or more remote transceivers of another device capable of wireless communication such as another WD, UE, or base station of a radio access network (RAN) according to one or more communication protocols, such as IEEE 802.12, CDMA, WCDMA, GSM, LTE, UTRAN, WiMax, or the like. Each transceiver may include transmitter 1233 and/or receiver 1235 to implement transmitter or receiver functionality, respectively, appropriate to the RAN links (e.g., frequency allocations and the like). Further, transmitter 1233 and receiver 1235 of each transceiver may share circuit components, software or firmware, or alternatively may be implemented separately.

In the illustrated embodiment, the communication functions of communication subsystem 1231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1231 may include cellular communication, Wi-Fi communication, Bluetooth communication, and GPS communication. Network 1243b may encompass wired and/or wireless networks such as a local-area network (LAN), a wide-area network (WAN), a computer network, a wireless network, a telecommunications network, another like network or any combination thereof. For example, network 1243b may be a cellular network, a Wi-Fi network, and/or a near-field network. Power source 1213 may be configured to provide alternating current (AC) or direct current (DC) power to components of UE 1200.

The features, benefits and/or functions described herein may be implemented in one of the components of UE 1200 or partitioned across multiple components of UE 1200. Further, the features, benefits, and/or functions described herein may be implemented in any combination of hardware, software or firmware. In one example, communication subsystem 1231 may be configured to include any of the components described herein. Further, processing circuitry 1201 may be configured to communicate with any of such components over bus 1202. In another example, any of such components may be represented by program instructions stored in memory that when executed by processing circuitry 1201 perform the corresponding functions described herein. In another example, the functionality of any of such components may be partitioned between processing circuitry 1201 and communication subsystem 1231. In another example, the non-computationally intensive functions of any of such components may be implemented in software or firmware and the computationally intensive functions may be implemented in hardware.

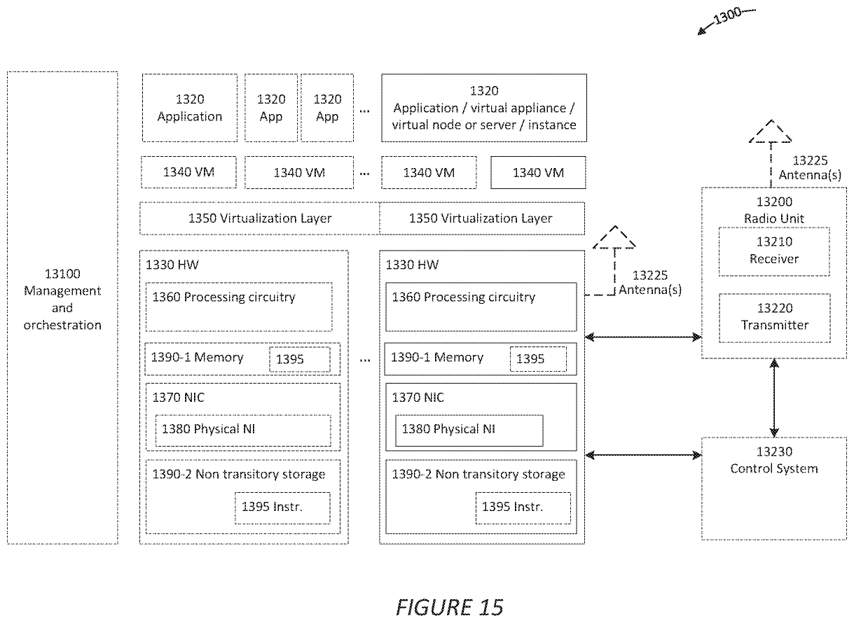

FIG. 15 is a schematic block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1300 hosted by one or more of hardware nodes 1330. Further, in embodiments in which the virtual node is not a radio access node or does not require radio connectivity (e.g., a core network node), then the network node may be entirely virtualized.

The functions may be implemented by one or more applications 1320 (which may alternatively be called software instances, virtual appliances, network functions, virtual nodes, virtual network functions, etc.) operative to implement some of the features, functions, and/or benefits of some of the embodiments disclosed herein. Applications 1320 are run in virtualization environment 1300 which provides hardware 1330 comprising processing circuitry 1360 and memory 1390. Memory 1390 contains instructions 1395 executable by processing circuitry 1360 whereby application 1320 is operative to provide one or more of the features, benefits, and/or functions disclosed herein.

Virtualization environment 1300, comprises general-purpose or special-purpose network hardware devices 1330 comprising a set of one or more processors or processing circuitry 1360, which may be commercial off-the-shelf (COTS) processors, dedicated Application Specific Integrated Circuits (ASICs), or any other type of processing circuitry including digital or analog hardware components or special purpose processors. Each hardware device may comprise memory 1390-1 which may be non-persistent memory for temporarily storing instructions 1395 or software executed by processing circuitry 1360. Each hardware device may comprise one or more network interface controllers (NICs) 1370, also known as network interface cards, which include physical network interface 1380. Each hardware device may also include non-transitory, persistent, machine-readable storage media 1390-2 having stored therein software 1395 and/or instructions executable by processing circuitry 1360. Software 1395 may include any type of software including software for instantiating one or more virtualization layers 1350 (also referred to as hypervisors), software to execute virtual machines 1340 as well as software allowing it to execute functions, features and/or benefits described in relation with some embodiments described herein.

Virtual machines 1340, comprise virtual processing, virtual memory, virtual networking or interface and virtual storage, and may be run by a corresponding virtualization layer 1350 or hypervisor. Different embodiments of the instance of virtual appliance 1320 may be implemented on one or more of virtual machines 1340, and the implementations may be made in different ways.

During operation, processing circuitry 1360 executes software 1395 to instantiate the hypervisor or virtualization layer 1350, which may sometimes be referred to as a virtual machine monitor (VMM). Virtualization layer 1350 may present a virtual operating platform that appears like networking hardware to virtual machine 1340.

As shown in FIG. 15, hardware 1330 may be a standalone network node with generic or specific components. Hardware 1330 may comprise antenna 13225 and may implement some functions via virtualization. Alternatively, hardware 1330 may be part of a larger cluster of hardware (e.g., such as in a data center or customer premise equipment (CPE)) where many hardware nodes work together and are managed via management and orchestration (MANO) 13100, which, among others, oversees lifecycle management of applications 1320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1340 may be a software implementation of a physical machine that runs programs as if they were executing on a physical, non-virtualized machine. Each of virtual machines 1340, and that part of hardware 1330 that executes that virtual machine, be it hardware dedicated to that virtual machine and/or hardware shared by that virtual machine with others of the virtual machines 1340, forms a separate virtual network elements (VNE).

Still in the context of NFV, Virtual Network Function (VNF) is responsible for handling specific network functions that run in one or more virtual machines 1340 on top of hardware networking infrastructure 1330 and corresponds to application 1320 in FIG. 15.

In some embodiments, one or more radio units 13200 that each include one or more transmitters 13220 and one or more receivers 13210 may be coupled to one or more antennas 13225. Radio units 13200 may communicate directly with hardware nodes 1330 via one or more appropriate network interfaces and may be used in combination with the virtual components to provide a virtual node with radio capabilities, such as a radio access node or a base station.

In some embodiments, some signaling can be affected with the use of control system 13230 which may alternatively be used for communication between the hardware nodes 1330 and radio units 13200.

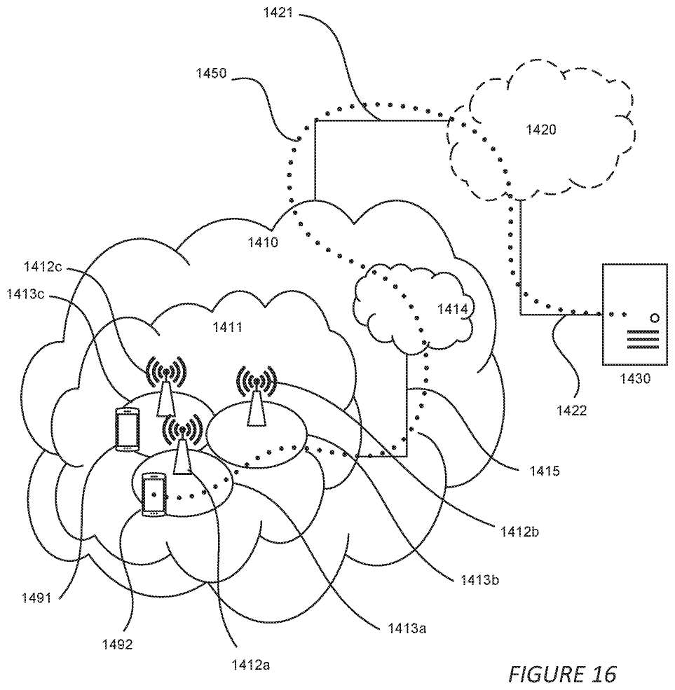

FIG. 16 illustrates a telecommunication network connected via an intermediate network to a host computer in accordance with some embodiments. In particular, with reference to FIG. 16, in accordance with an embodiment, a communication system includes telecommunication network 1410, such as a 3GPP-type cellular network, which comprises access network 1411, such as a radio access network, and core network 1414. Access network 1411 comprises a plurality of base stations 1412a, 1412b, 1412c, such as NBs, eNBs, gNBs or other types of wireless access points, each defining a corresponding coverage area 1413a, 1413b, 1413c. Each base station 1412a, 1412b, 1412c is connectable to core network 1414 over a wired or wireless connection 1415. A first UE 1491 located in coverage area 1413c is configured to wirelessly connect to, or be paged by, the corresponding base station 1412c. A second UE 1492 in coverage area 1413a is wirelessly connectable to the corresponding base station 1412a. While a plurality of UEs 1491, 1492 are illustrated in this example, the disclosed embodiments are equally applicable to a situation where a sole UE is in the coverage area or where a sole UE is connecting to the corresponding base station 1412.

Telecommunication network 1410 is itself connected to host computer 1430, which may be embodied in the hardware and/or software of a standalone server, a cloud-implemented server, and a distributed server or as processing resources in a server farm. Host computer 1430 may be under the ownership or control of a service provider, or may be operated by the service provider or on behalf of the service provider. Connections 1421 and 1422 between telecommunication network 1410 and host computer 1430 may extend directly from core network 1414 to host computer 1430 or may go via an optional intermediate network 1420. Intermediate network 1420 may be one of, or a combination of more than one of, a public, private or hosted network; intermediate network 1420, if any, may be a backbone network or the Internet; in particular, intermediate network 1420 may comprise two or more sub-networks (not shown).

The communication system of FIG. 16 as a whole enables connectivity between the connected UEs 1491, 1492 and host computer 1430. The connectivity may be described as an over-the-top (OTT) connection 1450. Host computer 1430 and the connected UEs 1491, 1492 are configured to communicate data and/or signaling via OTT connection 1450, using access network 1411, core network 1414, any intermediate network 1420 and possible further infrastructure (not shown) as intermediaries. OTT connection 1450 may be transparent in the sense that the participating communication devices through which OTT connection 1450 passes are unaware of routing of uplink and downlink communications. For example, base station 1412 may not or need not be informed about the past routing of an incoming downlink communication with data originating from host computer 1430 to be forwarded (e.g., handed over) to a connected UE 1491. Similarly, base station 1412 need not be aware of the future routing of an outgoing uplink communication originating from the UE 1491 towards the host computer 1430.

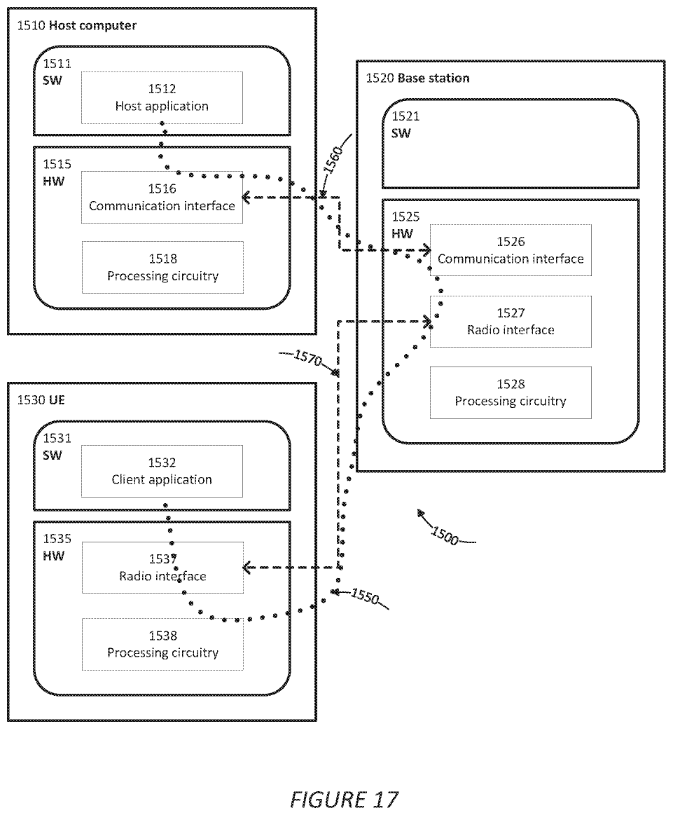

Example implementations, in accordance with an embodiment, of the UE, base station and host computer discussed in the preceding paragraphs will now be described with reference to FIG. 17. FIG. 17 illustrates host computer communicating via a base station with a user equipment over a partially wireless connection in accordance with some embodiments In communication system 1500, host computer 1510 comprises hardware 1515 including communication interface 1516 configured to set up and maintain a wired or wireless connection with an interface of a different communication device of communication system 1500. Host computer 1510 further comprises processing circuitry 1518, which may have storage and/or processing capabilities. In particular, processing circuitry 1518 may comprise one or more programmable processors, application-specific integrated circuits, field programmable gate arrays or combinations of these (not shown) adapted to execute instructions. Host computer 1510 further comprises software 1511, which is stored in or accessible by host computer 1510 and executable by processing circuitry 1518. Software 1511 includes host application 1512. Host application 1512 may be operable to provide a service to a remote user, such as UE 1530 connecting via OTT connection 1550 terminating at UE 1530 and host computer 1510. In providing the service to the remote user, host application 1512 may provide user data which is transmitted using OTT connection 1550.

Communication system 1500 further includes base station 1520 provided in a telecommunication system and comprising hardware 1525 enabling it to communicate with host computer 1510 and with UE 1530. Hardware 1525 may include communication interface 1526 for setting up and maintaining a wired or wireless connection with an interface of a different communication device of communication system 1500, as well as radio interface 1527 for setting up and maintaining at least wireless connection 1570 with UE 1530 located in a coverage area (not shown in FIG. 17) served by base station 1520. Communication interface 1526 may be configured to facilitate connection 1560 to host computer 1510. Connection 1560 may be direct or it may pass through a core network (not shown in FIG. 17) of the telecommunication system and/or through one or more intermediate networks outside the telecommunication system. In the embodiment shown, hardware 1525 of base station 1520 further includes processing circuitry 1528, which may comprise one or more programmable processors, application-specific integrated circuits, field programmable gate arrays or combinations of these (not shown) adapted to execute instructions. Base station 1520 further has software 1521 stored internally or accessible via an external connection.

Communication system 1500 further includes UE 1530 already referred to. Its hardware 1535 may include radio interface 1537 configured to set up and maintain wireless connection 1570 with a base station serving a coverage area in which UE 1530 is currently located. Hardware 1535 of UE 1530 further includes processing circuitry 1538, which may comprise one or more programmable processors, application-specific integrated circuits, field programmable gate arrays or combinations of these (not shown) adapted to execute instructions. UE 1530 further comprises software 1531, which is stored in or accessible by UE 1530 and executable by processing circuitry 1538. Software 1531 includes client application 1532. Client application 1532 may be operable to provide a service to a human or non-human user via UE 1530, with the support of host computer 1510. In host computer 1510, an executing host application 1512 may communicate with the executing client application 1532 via OTT connection 1550 terminating at UE 1530 and host computer 1510. In providing the service to the user, client application 1532 may receive request data from host application 1512 and provide user data in response to the request data. OTT connection 1550 may transfer both the request data and the user data. Client application 1532 may interact with the user to generate the user data that it provides.

It is noted that host computer 1510, base station 1520 and UE 1530 illustrated in FIG. 17 may be similar or identical to host computer 1430, one of base stations 1412a, 1412b, 1412c and one of UEs 1491, 1492 of FIG. 16, respectively. This is to say, the inner workings of these entities may be as shown in FIG. 17 and independently, the surrounding network topology may be that of FIG. 16.

In FIG. 17, OTT connection 1550 has been drawn abstractly to illustrate the communication between host computer 1510 and UE 1530 via base station 1520, without explicit reference to any intermediary devices and the precise routing of messages via these devices. Network infrastructure may determine the routing, which it may be configured to hide from UE 1530 or from the service provider operating host computer 1510, or both. While OTT connection 1550 is active, the network infrastructure may further take decisions by which it dynamically changes the routing (e.g., on the basis of load balancing consideration or reconfiguration of the network).

Wireless connection 1570 between UE 1530 and base station 1520 is in accordance with the teachings of the embodiments described throughout this disclosure. One or more of the various embodiments improve the performance of OTT services provided to UE 1530 using OTT connection 1550, in which wireless connection 1570 forms the last segment. More precisely, the teachings of these embodiments enable CBG-based retransmissions and thereby provide benefits such as more efficient use of resources.

A measurement procedure may be provided for the purpose of monitoring data rate, latency and other factors on which the one or more embodiments improve. There may further be an optional network functionality for reconfiguring OTT connection 1550 between host computer 1510 and UE 1530, in response to variations in the measurement results. The measurement procedure and/or the network functionality for reconfiguring OTT connection 1550 may be implemented in software 1511 and hardware 1515 of host computer 1510 or in software 1531 and hardware 1535 of UE 1530, or both. In embodiments, sensors (not shown) may be deployed in or in association with communication devices through which OTT connection 1550 passes; the sensors may participate in the measurement procedure by supplying values of the monitored quantities exemplified above, or supplying values of other physical quantities from which software 1511, 1531 may compute or estimate the monitored quantities. The reconfiguring of OTT connection 1550 may include message format, retransmission settings, preferred routing etc.; the reconfiguring need not affect base station 1520, and it may be unknown or imperceptible to base station 1520. Such procedures and functionalities may be known and practiced in the art. In certain embodiments, measurements may involve proprietary UE signaling facilitating host computer 1510′s measurements of throughput, propagation times, latency and the like. The measurements may be implemented in that software 1511 and 1531 causes messages to be transmitted, in particular empty or ‘dummy’ messages, using OTT connection 1550 while it monitors propagation times, errors etc.

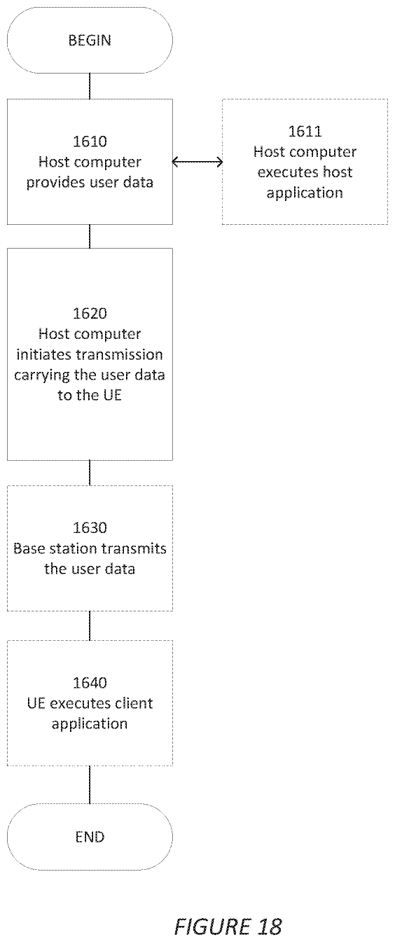

FIG. 18 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 18 will be included in this section. In step 1610, the host computer provides user data. In substep 1611 (which may be optional) of step 1610, the host computer provides the user data by executing a host application. In step 1620, the host computer initiates a transmission carrying the user data to the UE. In step 1630 (which may be optional), the base station transmits to the UE the user data which was carried in the transmission that the host computer initiated, in accordance with the teachings of the embodiments described throughout this disclosure. In step 1640 (which may also be optional), the UE executes a client application associated with the host application executed by the host computer.

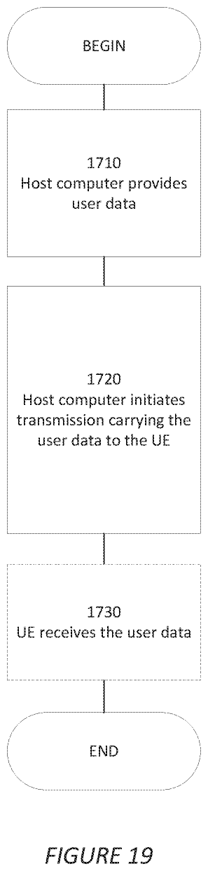

FIG. 19 is a flowchart illustrating a method implemented in a communication system, in accordance with one embodiment. The communication system includes a host computer, a base station and a UE which may be those described with reference to FIGS. 12 and 12. For simplicity of the present disclosure, only drawing references to FIG. 19 will be included in this section. In step 1710 of the method, the host computer provides user data. In an optional substep (not shown) the host computer provides the user data by executing a host application. In step 1720, the host computer initiates a transmission carrying the user data to the UE. The transmission may pass via the base station, in accordance with the teachings of the embodiments described throughout this disclosure. In step 1730 (which may be optional), the UE receives the user data carried in the transmission.

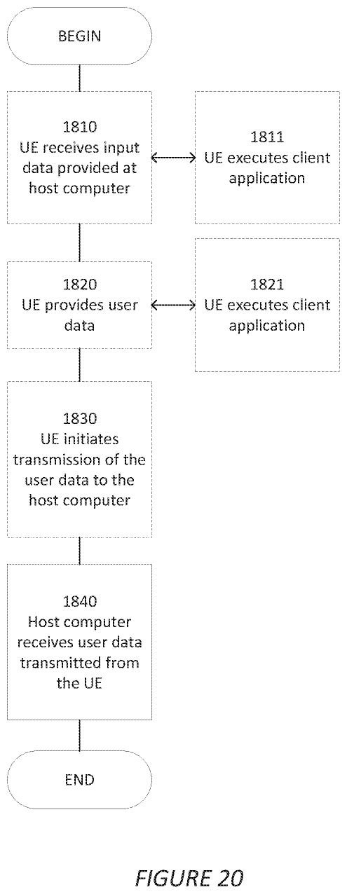

FIG. 20 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 20 will be included in this section. In step 1810 (which may be optional), the UE receives input data provided by the host computer. Additionally or alternatively, in step 1820, the UE provides user data. In substep 1821 (which may be optional) of step 1820, the UE provides the user data by executing a client application. In substep 1811 (which may be optional) of step 1810, the UE executes a client application which provides the user data in reaction to the received input data provided by the host computer. In providing the user data, the executed client application may further consider user input received from the user. Regardless of the specific manner in which the user data was provided, the UE initiates, in substep 1830 (which may be optional), transmission of the user data to the host computer. In step 1840 of the method, the host computer receives the user data transmitted from the UE, in accordance with the teachings of the embodiments described throughout this disclosure.

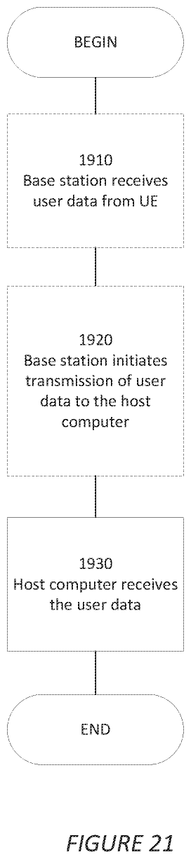

FIG. 21 is a flowchart illustrating a method implemented in a communication system, in accordance with one embodiment. The communication system includes a host computer, a base station and a UE which may be those described with reference to FIGS. 11 and 12. For simplicity of the present disclosure, only drawing references to FIG. 21 will be included in this section. In step 1910 (which may be optional), in accordance with the teachings of the embodiments described throughout this disclosure, the base station receives user data from the UE. In step 1920 (which may be optional), the base station initiates transmission of the received user data to the host computer. In step 1930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Additional information may be found in Appendix A, which is incorporated in its entirety by reference.

1. A method of retransmission implemented by a user equipment, said method comprising:
receiving, for each of one or more acknowledgement processes, transport block level feedback indicating an acknowledgement (ACK) or negative acknowledgement (NACK) for a transport block associated with the acknowledgement process;
receiving, for each of one or more negatively acknowledged transport blocks, retransmission control information indicating whether the base station expects retransmission at the transport block level or code block group level;
for one or more negatively acknowledged transport blocks where code block group level retransmission is indicated by the retransmission control information, receiving code block group level feedback indicating an acknowledgement (ACK) or negative acknowledgement (NACK) for each of one or more code block groups in the transport block; and
retransmitting one or more of the negatively acknowledged code block groups in the negatively acknowledged transport blocks for which code block group level retransmission is indicated.

2. The method of claim 1 wherein receiving transport block level feedback comprises receiving a first bitmap where each bit indicates the acknowledgement (ACK) or negative acknowledgement (NACK) of a respective transport block associated with one of the acknowledgement processes.

3. The method of claim 1 wherein receiving retransmission control information comprises receiving a second bitmap where each bit indicates either transport block level retransmission or code block group level retransmission for a respective one of the negatively acknowledged transport blocks.

4. The method of claim 1 wherein receiving code block group level feedback comprises receiving a third bitmap corresponding to one of the negatively acknowledged transport blocks where each bit represents an acknowledgement (ACK) or negative acknowledgement (NACK) of a respective code block group in the negatively acknowledged transport block.

5. The method of claim 1 further comprising retransmitting one or more of the negatively acknowledged transport blocks for which transport block level retransmission is indicated.

6. The method of claim 1 wherein receiving transport block level feedback comprises:
receiving an acknowledgement (ACK) in the case where all code block groups in the transport block are successfully received; and
receiving a negative acknowledgement (NACK) in the case where at least on code block group in the transport block is not successfully received.

7. The method of claim 1 further comprising transmitting uplink control information to the base station (100, 500) indicating whether a retransmission is a CBG-based retransmission of a TB-based retransmission.

8. The method of claim 1 further comprising rate matching a CBG-based retransmission to fit an available number of CG resources.

9. A method implemented by a base station of providing feedback for uplink transmissions, said method comprising:
transmitting, for each of one or more acknowledgement processes, transport block level feedback indicating an acknowledgement (ACK) or negative acknowledgement (NACK) of a transport block associated with the acknowledgement process;
transmitting, for one or more negatively acknowledged transport blocks, retransmission control information indicating whether the base station expects retransmission at a transport block level or a code block group level; and
for one or more negatively acknowledged transport blocks where code block group level retransmission is indicated by the retransmission control information, transmitting code block group level feedback indicating an acknowledgement (ACK) or negative acknowledgement (NACK) for one or more code block groups in the transport block.

10. The method of claim 9 wherein transmitting transport block level feedback comprises transmitting a first bitmap where each bit indicates the acknowledgement (ACK) or negative acknowledgement (NACK) for a respective transport block associated with one of the acknowledgement processes.

11. The method of claim 9 wherein transmitting retransmission control information comprises transmitting a second bitmap where each bit indicates either transport block level retransmission or code block group level retransmission for a respective one of the negatively acknowledged transport blocks.

12. The method of claim 9 wherein transmitting code block group level feedback comprises transmitting a third bitmap corresponding to one of the negatively acknowledged transport blocks where each bit represents an acknowledgement (ACK) or negative acknowledgement (NACK) of a respective code block group in the negatively acknowledged transport block.

13. The method of claim 9 further comprising receiving a retransmission of one or more of the negatively acknowledged code block groups in the one or more negatively acknowledged transport blocks for which code block group level retransmission is indicated.

14. The method of claim 9 further comprising receiving a retransmission of one or more of the negatively acknowledged transport blocks for which transport block level retransmission is indicated.

15. The method of claim 9 wherein transmitting transport block level feedback comprises:
transmitting an acknowledgement (ACK) in the case where all code block groups in the transport block are successfully received; and
transmitting a negative acknowledgement (NACK) in the case where at least one code block group in the transport block is not successfully received.

16. The method of claim 9 further comprising receiving uplink control information indicating whether a retransmission is a CBG-based retransmission of a TB-based retransmission.

17. A user equipment in a wireless communication network, said user equipment comprising, said user equipment comprising:
communication circuitry configured for communication with a base station the wireless communication network; and
processing circuitry configured to:
receive, for each of one or more acknowledgement processes, transport block level feedback indicating an acknowledgement (ACK) or negative acknowledgement (NACK) for each of one or more transport blocks associated with the acknowledgement process;
receive, for each of one or more negatively acknowledged transport blocks, retransmission control information indicating whether the base station expects retransmission at the transport block level or code block group level; and
for one or more negatively acknowledged transport blocks where the second bitmap indicates code block group level retransmission, receive code block group level feedback indicating an acknowledgement (ACK) or negative acknowledgement (NACK) for each of one or more code block groups in the transport block; and
retransmit one or more of the negatively acknowledged code block groups in the negatively acknowledged transport blocks for which code block group level retransmission is indicated.

18. The user equipment according to claim 17, wherein the processing circuitry is further configured to process one or more of
receive transport block level feedback comprises receiving a first bitmap where each bit indicates the acknowledgement (ACK) or negative acknowledgement (NACK) of a respective transport block associated with one of the acknowledgement processes;
receive retransmission control information comprises receiving a second bitmap where each bit indicates either transport block level retransmission or code block group level retransmission for a respective one of the negatively acknowledged transport blocks;
receive code block group level feedback comprises receiving a third bitmap corresponding to one of the negatively acknowledged transport blocks where each bit represents an acknowledgement (ACK) or negative acknowledgement (NACK) of a respective code block group in the negatively acknowledged transport block;
retransmission of one or more of the negatively acknowledged transport blocks for which transport block level retransmission is indicated;
receive an acknowledgement (ACK) in the case where all code block groups in the transport block are successfully received;
receive a negative acknowledgement (NACK) in the case where at least on code block group in the transport block is not successfully received;
transmission of uplink control information to the base station indicating whether a retransmission is a CBG-based retransmission of a TB-based retransmission; and
rate matching a CBG-based retransmission to fit an available number of CG resources.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)
